(19) United States
(12) Patent Application Publication
(10) Pub. No.: US 2026/0285598 A1
(43) Pub. Date: Sep. 24, 2026

(54) ORDER-PICKING SYSTEM, AND MEHTOD FOR ORDER-PICKING PIECE GOODS

(71) Applicant: FERAG AG, CH-8340 HINWIL (CH)

(72) Inventors: Markus BRETZ, Hinwil (CH); Marco Antonio GIARRUSSO, Hinwil (CH)

(73) Assignee: FERAG AG, CH-8340 HINWIL (CH)

(21) Appl. No.: 19/479,587

(22) PCT Filed: Apr. 26, 2024
(86) PCT No.: PCT/IB2024/054091

§ 371 Date: Oct. 28, 2025

(30) Foreign Application Priority Data
Apr. 28, 2023 (CH) CH000455/2023

(51) Int. Cl. B65G 1/137; B65G 1/04; B65G 1/10

(52) U.S. Cl. CPC B65G 1/1376; B65G 1/0464; B65G 1/0485; B65G 1/10

(57) ABSTRACT

A facility (1) for picking piece goods comprises a storage device (2) having a plurality of shelf trays (22, 22′, 22″, 22″′) on which piece goods (91) and/or storage containers (92) with piece goods can be placed; having a plurality of storage bays (21, 21′) in which the shelf trays (22, 22′, 22″, 22″′) can be placed; and having a storage location transfer device (25, 250, 253) configured to transfer shelf trays from one storage bay to a different storage bay. The picking facility further comprises a picking station and/or a picking device (3, 3a, 3b), having at least one picking location (32, 32a, 32b) on which a shelf tray can be placed, wherein the at least one picking location is also a storage bay of the storage device; and a conveying device (4, 4′, 37) configured to convey piece goods (91′) placed on the conveying device to a downstream processing station (51). The picking station and/or the picking device (3, 3a, 3b) of the picking facility (1) has a transfer device (31) configured to receive piece goods (91) and place it on the at least one conveying device (4, 4′).

### BACKGROUND OF THE INVENTION

### Field of the Invention

The invention relates to a picking facility, a storage facility having a picking facility, and a method for picking piece goods.

### Discussion of Related Art

Continuously growing volumes in online trade require retailers, suppliers and logistics businesses to efficiently handle the goods to be processed, in particular with respect to production, provision and storage of the goods as well as picking and transporting the goods to the customer.

In this description, the terms goods, unit of goods, article and piece goods are used synonymously and can comprise mainly single objects, but also packaged goods such as packs and, overall, objects that can be handled individually, in particular also semi-finished products, spare parts, etc.

If a high number of different items or goods are to be kept in a storage and picking facility and should be readily removed from the storage and provided for picking when needed, storing and removing of the articles must be accomplished as efficiently and quickly as possible. Accordingly, various automated storage and picking facilities have been developed.

Typically, conventional automated picking facilities comprise a long-term storage, a short-term storage, optionally including a sorting system, and an output for goods.

In the long-term storage, the various types of units of goods are stored and kept ready for later processing. For example, long-term storages can be implemented as high shelf storages, which allow to make good use of the storage space and for which highly automated access systems are available. Smaller units of goods can be stored in larger storage containers in sorted fashion, from which the required units of goods can be retrieved when needed. Due to their size and their design, which is geared towards an optimal use of space, the access times in conventional long-term storages tend to be long, which can result in a bottleneck in terms of logistics when throughput rates are high.

In short-term storage, units of goods of one or more picking orders retrieved from the long-term storage can be collected and buffered for further processing. Experience suggests that frequently required units of goods can be kept ready as well. As a rule, short-time storages have considerably shorter access times than long-term storages.

In general, a system interface is required between the long-term storage and the short-term storage. In the most basic case, for example, an operator removes a unit of goods from a storage container of the long-term storage and transfers it to the short-time storage.

Units of goods of a picking order can be removed from the short-term storage for further processing, for example, in order to then be sorted and supplied to an output of goods, where the units of goods of the completed picking order can be packaged and shipped.

WO 98/49075 A1 describes an automated high shelf storage system adapted as a long-term storage. Vertical support structures form a high number of vertical storage slots disposed in a grid-like pattern. In the storage slots, standardized storage containers are stacked above one another from the upper side by means of a crane-type storage and retrieval machine, which corresponds to a first-in last-out storage in function. In order to gain access to a certain storage container, the overlying storage containers are removed and temporarily or permanently transferred to a different storage location, and the now-accessible storage container is removed from the storage slot. The storage and retrieval machines are designed such that they can travel horizontally on the uppermost plane of the storage, rolling along an xy grid pattern. WO 2022/214579 A1 and WO 2015/193278 A1 show further embodiments of such storage and retrieval machines. Such high shelf storage systems allow for a very high storage density. However, the average access time for removing a storage container from the storage is long while storing a container can be faster. In addition, high access frequencies can result in access overload and thus further delay. Accordingly, such storage systems are mainly useful for long-term storages.

WO 2019/141877 A1 shows a similar long-term storage system with storage slots, in which, at certain points of the xy storage grid pattern, the storage and retrieval machines can transfer the individually conveyed storage containers to picking locations outside of the storage slots. An operator can then retrieve the objects needed for a picking order from the storage containers provided in this way. As soon as a storage container is completely empty, it is removed from the picking location. Returning an only partially empty storage container from a picking location to the long-term storage system is possible. However, due to the inherently long access times of the storage and retrieval machines, this is very inefficient.

WO 2011/104159 A1 shows a container-based high shelf storage system for storing and removing storage containers for a picking facility. The storage system has multiple shelves divided into shelf blocks with multiple shelf planes disposed above one another, each having a high number of shelf storage locations disposed horizontally adjacent to one another for receiving a respective storage container. A vertically and horizontally moveable storage and retrieval machine is disposed at a longitudinal side of the shelf to place a storage container at one of the shelf storage locations or retrieve it from there. A horizontal conveying device extends substantially parallel to the shelf planes and extends above and/or below each shelf block and adjoining each shelf block. Due to its access times, such a storage system is also mainly useful for long-term storages.

WO 2018/082749 A1 shows a high shelf storage system in which a vertically and horizontally moveable storage and retrieval machine is disposed at a longitudinal side of the shelf, which can retrieve storage containers from the high shelf storage and place them on a roller ramp on which the storage container can roll to a picking location outside of the longitudinal side of the shelf storage. An operator can then retrieve the objects needed for a picking order from the storage containers provided in this way. Such a storage system has limited storage capacity as the storage system only includes substantially two rows of shelves. In addition, the slow access times of the storage and retrieval machine limit the speed of the supply of storage containers.

DE 102021129397 B3 shows a high shelf storage system in which a horizontally moveable storage and retrieval machine is provided on each storage plane between two shelves. Vertical transport is accomplished by means of a lifting device which is disposed extending over multiple storage planes in a shelf.

US 2023/0033636 A1 and US 2018/0178979 A1 show container-based high shelf storage systems in which storage and retrieval machines disposed between the shelves retrieve storage containers from the high shelf and place them on a horizontal conveyor, which conveys them to a picking station where the articles needed for a picking order are retrieved. Next, the storage containers are returned to the high shelf storage in an analogous manner.

US 2010/0036521 A1 shows an automated picking facility which allows conveying units of goods to a workplace in a predetermined order. Shelf trays, on which units of goods are stored, preferably in sorted fashion, are disposed in a high shelf storage. Storage and retrieval machines allow the transfer of units of goods between adjacent shelves and the placing of units of goods on certain transfer locations of a shelf. Vertical conveyors allow the removal of units of goods from the transfer locations, storage and retrieval in a short-time storage shelf and the transfer to a belt conveyor. The units of goods can be placed on the belt conveyor in a predetermined order to thereby obtain a sorted compiling of a picking order.

EP 3919415 A1 shows a dynamic shelf for use as a picking facility, having a storage device in the form of a paternoster shelf or a shelf storage with a storage and retrieval machine. A storage container is moved to an access station within the storage device as needed, where an operator can retrieve an article required for a picking order and place it on a belt conveyor. Filling the dynamic shelf is done via the access station, which results in a reduced access capacity.

EP 0705775 A2 shows an automated picking device for a picking facility in which special magazine-type storage containers having built-in actuators are configured to transfer containers for liquids, in particular bottles and the like, through the bottom of the container into a delivery device therebelow in order to thereby refill them. In order to complete a picking order, the small parts are then dropped from the delivery device onto a chute, on which they slide onto a collecting conveyor, which ultimately places the small parts in a collector provided on a conveyor belt. Completely empty storage containers are removed by an operator and replaced by a new, filled storage container.

There is general demand for improvements in this field.

### SUMMARY OF THE INVENTION

It is the object of the invention to provide a picking facility which counteracts at least one of the aforementioned and other drawbacks. In particular, such a picking facility is intended to allow efficient picking and, at the same time, ensure efficient operation of an upstream long-term storage.

According to the present invention, these and other objects are achieved by the elements of the independent claims. Further advantageous embodiments are set forth in the dependent claims.

The solution according to the invention can be further improved by various features, which are each advantageous in their own right and can be combined with one another unless otherwise specified. These embodiments and the advantages coming with them are discussed in more detail below.

A first aspect of the invention relates to a facility for picking piece goods.

A facility for picking piece goods according to the invention comprises a storage device having a plurality of shelf trays on which piece goods and/or storage containers with piece goods can be placed; having a plurality of storage bays in which the shelf trays can be placed; and having a storage location transfer device configured to transfer shelf trays from one storage bay to a different storage bay. The picking facility further comprises a picking station and/or a picking device, having at least one picking location on which a shelf tray can be placed, wherein the at least one picking location is also a storage bay of the storage device; and a conveying device configured to convey piece goods placed on the conveying device to a downstream processing station. The picking station and/or the picking device of the picking facility has a transfer device configured to receive piece goods and place it on the at least one conveying device.

Such a picking facility according to the invention has the advantage, among others, that storage containers and/or piece goods can be placed directly onto the shelf tray. The shelf tray can then be transferred to the picking location by means of the storage location transfer device. This allows decoupling the picking process and the supply of new piece goods into the picking facility. In this way, for example, storage containers obtained from a long-term storage and/or piece goods from the storage containers can be placed on the shelf tray without involving the picking location and, thus, the picking process.

Advantageously, in such a picking facility according to the invention the conveying device is designed as a horizontal conveying device having a substantially horizontal conveying surface.

In particular, such a horizontal conveying device can be implemented as a modular belt conveyor, plate chain conveyor, roller conveyor, tray conveyor or tilt tray conveyor.

Advantageously, in such a picking facility according to the invention the transfer device is configured to convey piece goods placed in a drop hole of the transfer device to the at least one conveying device under the action of gravity.

In another advantageous variant of a picking facility according to the invention the transfer device is designed as a manipulator device, in particular as a manipulator device having a robot arm.

The robot arm can be a gripping element in the form of a mechanical gripping tool capable of grasping an article. Alternatively, or in addition, the robot arm can have a gripping element in the form of a vacuum gripper, which can generate a temporary negative pressure at an elastic gripping element by means of a vacuum pump in order to be able to grasp an article at a surface. The robot arm can also have two or more of such gripping elements, mounted on a rotatable platform which is capable of rotating the currently required or best-suited gripping tool to the operative position of the robot arm. Likewise, the manipulator device can comprise a changer magazine for gripping elements from which a robot arm having a quick-coupling device can always receive the required gripping element.

Alternatively, or in addition, in such a picking facility according to the invention the drop hole of the transfer device can be disposed in the region of one of the picking locations of the picking station and/or the picking device.

Advantageously, in such a picking facility according to the invention the drop hole of the transfer device is formed in the shelf trays.

This allows, among other things, a space-saving construction of a picking facility.

Further advantageously, in such a picking facility according to the invention the transfer device of the picking station and/or the picking device has a drop shaft, a guide element and/or a slide chute on which piece goods can be transferred to the conveying device under the action of gravity.

A slide chute can be designed in particular a as a spiral slide chute. Such a spiral slide chute allows conveying an article, under the action of gravity, substantially vertically over a large difference in height without running the risk of causing mechanical damage to the article.

Also advantageously, in such a picking facility according to the invention the transfer device of the picking station and/or the picking device has a pre-sorting device, which is configured to transfer piece goods, which have been transferred to the transfer device in a certain order, to the at least one conveying device in a certain different order.

In an advantageous embodiment of a picking facility according to the invention the storage device is implemented as a vertically circumferential paternoster shelf storage, having a storage location transfer device designed as a paternoster conveyor with a plurality of shelf trays, on which piece goods and/or storage containers with piece goods can be placed, so that the storage location transfer device can convey the shelf trays along the various storage bays of the storage device.

In another advantageous embodiment of a picking facility according to the invention the storage device is implemented as a shelf storage, having one or two shelf units, each including a plurality of storage bays disposed above one another. The storage location transfer device has a storage and retrieval machine configured to transfer a shelf tray from one storage bay to a different storage bay.

Advantageously, in such a picking facility according to the invention the storage device has two shelf units horizontally spaced apart from one another, and the storage and retrieval machine is disposed between the two shelf units.

Advantageously, in a picking facility according to the invention the picking locations of the picking station and/or the picking device are disposed directly above one another.

Advantageously, in a picking facility according to the invention a conveying device is disposed arranged the storage device.

In another advantageous embodiment of a picking facility according to the invention the conveying device is configured to convey piece goods out of the picking facility.

Also advantageously, in a picking facility according to the invention the conveying device is disposed below the picking locations of the picking station and/or the picking device.

In an advantageous embodiment of a picking facility according to the invention a conveying device is implemented as a horizontal conveying device, in particular as a belt conveying device, as a modular belt conveying device, as a plate chain conveying device, as a roller conveying device, as a tray conveying device, or as a tilt tray conveying device.

In another advantageous embodiment of a picking facility according to the invention a conveying device is implemented as an overhead conveying device, in particular as an overhead pouch conveying device.

Advantageously, a picking facility according to the invention comprises a transfer interface configured to place storage containers from an upstream storage device on a shelf tray that is disposed in a storage bay of the storage device of the picking facility provided for this transfer.

Advantageously, in such a picking facility according to the invention the transfer interface has a device configured to retrieve piece goods from a storage container on the shelf tray of the storage bay provided for the transfer and to place it on a shelf tray that is placed in a different storage bay, or is held by a storage and retrieval machine of a storage location transfer device.

Advantageously, such a device for retrieving piece goods is designed as a manipulator device having a robot arm.

The device can be disposed within the transfer interface. It can also be a component of a storage and retrieval machine.

The device can be stationary arranged or it can be designed to be mobile and movable.

The robot arm can be a gripping element in the form of a mechanical gripping tool capable of grasping an article. Alternatively, or in addition, the robot arm can have a gripping element in the form of a vacuum gripper, which can generate a temporary negative pressure at an elastic gripping element by means of a vacuum pump in order to be able to grasp an article at a surface. The robot arm can also have two or more of such gripping elements, mounted on a rotatable platform which is capable of rotating the currently required or best-suited gripping tool to the operative position of the robot arm. Likewise, the manipulator device can comprise a changer magazine for gripping elements from which a robot arm having a quick-coupling device can always receive the required gripping element.

Another advantageous embodiment of a picking facility according to the invention comprises a transfer device configured to convey piece goods placed in a drop hole of the transfer device to the at least one conveying device under the action of gravity; and a device configured to retrieve piece goods from a shelf tray and transfer it to the transfer device.

Advantageously, such a device for retrieving piece goods is designed as a manipulator device having a robot arm, for example a robot arm, as already described above.

The device can be stationarily arranged, or it can be designed to be mobile and moveable.

The device can be disposed within a transfer interface or disposed at a picking location. It can also be a component of a storage and retrieval machine.

The device can be stationarily arranged, or it can be designed to be mobile and moveable.

Said shelf tray, from which the piece goods can be retrieved, can be the shelf tray on the picking location or a different shelf tray in the storage device of the picking facility.

Said transfer device can be the transfer device of a picking station and/or a picking device or a separate transfer device. The transfer device can have a drop shaft, a guide element and/or a slide chute on which piece goods can be transferred to the conveying device under the action of gravity.

A slide chute of the transfer device can in particular be designed a as a spiral slide chute. Such a spiral slide chute allows conveying an article, under the action of gravity, substantially vertically over a large difference in height without running the risk of causing mechanical damage to the article.

In a particularly advantageous variant of a picking facility according to the invention, a transfer device having a drop hole in the region of a transfer interface can be provided, for example. A manipulator device can then transfer an article required for a picking order directly to this transfer device, which places the article on the conveying device.

Such a design allows bypassing the picking station and/or the picking device when articles are needed soon, consequently reducing the internal relocation processes of the picking facility and thus increasing efficiency of the picking facility.

A further advantageous embodiment of a picking facility according to the invention has a picking device with a picking location wherein the picking device comprises a horizontal conveying device that is disposed on the picking location, and onto which piece goods can be placed by a storage and retrieval machine of the picking facility. The horizontal conveying device is configured to convey piece goods placed on the horizontal conveying device to a downstream processing station.

Advantageously, in one such picking facility according to the invention the storage and retrieval machine of the picking facility has a manipulator device capable of placing piece goods onto the horizontal conveying device of the picking device.

Advantageously, the manipulator device is designed as a manipulator device having a robot arm, as already described above.

Another advantageous embodiment of a picking facility according to the invention comprises a picking device with a picking location wherein the picking device has a manipulator device configured to retrieve articles from a shelf tray on the picking location and to transfer them to a conveying device.

The manipulator device can be designed as a robot arm, as already discussed above.

Another advantageous embodiment of a picking facility according to the invention comprises a processing station configured to transfer piece goods supplied by a conveying device of the picking facility to a downstream conveying system of a storage system.

Particularly advantageously, in such a system the downstream conveying system of the storage system is an overhead conveying system, in particular an overhead pouch conveying system.

In conjunction with picking facilities, storage systems and methods according to the invention it should be noted that all actions and processes which can be performed by a human operator during operation can alternatively be performed with the aid of a suitably designed robot device, in particular the manipulating of storage containers and piece goods at a picking station. Accordingly, the picking facilities and storage systems described herein can optionally be equipped with an additional suitable robot device.

A second aspect of the invention relates to a storage system.

A storage system according to the invention comprises a picking facility according to the invention and a long-time storage for storing a plurality of storage containers, which is connected to the picking facility in terms of conveying

Advantageously, in a storage system according to the invention, the long-time storage is implemented as a crate stack storage device or as a shelf storage device.

Alternatively, or in addition, a storage system according to the invention can have a downstream conveying system as well as a downstream processing station configured to transfer piece goods supplied by a conveying device from the picking facility to the downstream conveying system.

Advantageously, in a storage system according to the invention, the downstream conveying system of the storage system is an overhead conveying system, in particular an overhead pouch conveying system.

Such a processing station can have means configured to determine the identity of an article. For example, such means can comprise identification units capable of reading a one-dimensional or two-dimensional optical identification code on the article. Such means can also comprise an RFID transceiver unit capable of reading data from an RFID tag on the article.

Furthermore, such a processing station can have means configured to temporarily open a provided overhead conveying pouch of a downstream overhead pouch conveying system of the storage system, in order to be able to put a provided article into the overhead conveying pouch.

In another advantageous embodiment of a storage system according to the invention the long-term storage is implemented as a crate stack storage device with at least one storage and retrieval machine. The at least one storage and retrieval machine is configured to accept storage containers from a transfer interface of the picking facility and convey them within the long-term storage to a processing station and/or to a picking device.

In such a case the conveying device of a picking facility according to the invention is functionally implemented by the storage and retrieval machines of the crate stack storage, among others.

In a further advantageous embodiment of a storage system according to the invention the long-term storage is implemented as a crate stack storage device with at least one storage and retrieval machine; and the at least one storage and retrieval machine is configured to transfer storage containers from the long-term storage to a transfer interface of the picking facility.

Advantageously, in such a case the processing station and/or the picking device is equipped with a manipulator device configured to retrieve articles from a storage container supplied by the storage and retrieval machines of the crate stack storage and an optional downstream horizontal conveyor.

Particularly advantageously, in such an embodiment of a storage system according to the invention the processing station, or the picking device, respectively, has a manipulator device configured to retrieve articles from storage containers and transfer them to the downstream conveying system of the storage system. The storage containers were supplied via the long-term storage.

Supplying the storage containers can be performed in particular by storage and retrieval machines of a long-term storage in the form of a crate stack storage device.

The downstream conveying system of the storage system can be an overhead conveying system, in particular an overhead pouch conveying system.

The direct transfer by means of the manipulator device to the downstream conveying system eliminates the need for an intermediate further conveyor and passive guiding devices. In particular, this allows a more compact construction.

Advantageously, the manipulator device is designed in the form of a robot arm.

Particularly advantageously, the robot arm of the manipulator device has a gripping element in the form of a mechanical gripping tool capable of grasping an article.

Alternatively, or in addition, the robot arm can have a gripping element in the form of a vacuum gripper, which can apply a temporary negative pressure at an elastic suction cup by means of a vacuum pump in order to be able to grasp an article at a surface.

The robot arm can also have two or more of such gripping elements, mounted on a rotatable platform which is capable of rotating the currently required or best-suited gripping tool to the operative position of the robot arm. Likewise, the manipulator device can provide a changer magazine for gripping elements from which a robot arm having a quick-coupling device can always receive the required gripping element.

The manipulator device can transfer the articles directly to a downstream processing station, or to a conveying device which transports them to the downstream processing station.

A third aspect of the invention relates to a method for picking piece goods.

In a picking method according to the invention a picking facility according to the invention or a storage system according to the invention is provided; a certain shelf tray of the picking facility, on which one or more pieces of piece goods required for a certain picking order are transferred from a storage bay of the storage device of the picking facility to a picking location of the picking facility; and one or more pieces of piece goods required for a certain picking order are retrieved from the certain shelf tray on the at least one picking location and placed on a conveying device.

Advantageously, in such a method according to the invention said piece goods are then transferred to a downstream conveying system of a storage system by the conveying device.

Particularly advantageously, in such a method according to the invention the downstream conveying system of the storage system is an overhead conveying system, in particular an overhead pouch conveying system.

A fourth aspect of the invention relates to a storage system.

A storage system according to the invention comprises a long-term storage in the form of a crate stack storage device for storing a plurality of storage containers, in which piece goods can be stored, wherein the crate stack storage device has at least one storage and retrieval machine capable of retrieving, moving and/or placing storage containers within the crate stack storage device; a picking facility for picking piece goods; wherein the picking facility has a storage device with a plurality of shelf trays, on which storage containers with piece goods can be placed; with a plurality of storage bays, in which the shelf trays can be placed; and with a storage location transfer device configured to transfer shelf trays from one storage bay to a different storage bay; and a transfer interface configured to make sure that the at least one storage and retrieval machine of the crate stack storage device can accept a storage container from the transfer interface and/or transfer it to the transfer interface by the at least one storage and retrieval machine placing the storage container on a shelf tray or retrieving it from this shelf tray, which is placed in a storage bay of the storage device of the picking facility provided for this transfer.

Advantageously, in a storage system according to the invention the at least one storage and retrieval machine is configured to convey storage containers accepted from the transfer interface within the long-term storage to a processing station and/or to a picking device.

Advantageously, in a storage system according to the invention the transfer interface has a device configured to retrieve piece goods from a storage container on the shelf tray of the storage bay provided for the transfer and to place it on a shelf tray which is placed in a different storage bay or held by a storage and retrieval machine of a storage location transfer device.

Particularly advantageously, the device for retrieving piece goods is designed as a manipulator device having a robot arm.

Such manipulator devices have been already discussed in detail above.

Advantageously, in a storage system according to the invention the picking facility has a picking station having at least one picking location on which a shelf tray can be placed, wherein the at least one picking location is also a storage bay of the storage device.

In a further advantageous embodiment of a storage system according to the invention the picking facility has a conveying device configured to convey piece goods placed on the conveying device to a downstream processing station.

In another advantageous embodiment of a storage system according to the invention the picking station and/or an optionally present picking device of the picking facility has a transfer device configured to receive piece goods and place them onto the at least one conveying device.

Advantageously, in such a storage system the transfer device is configured to convey piece goods placed in a drop hole of the transfer device to the at least one conveying device under the action of gravity.

Alternatively, or in addition, in such a storage system the drop hole of the transfer device is disposed in the region of one of the picking locations of the picking station and/or the picking device.

Also, alternatively or in addition, advantageously the drop hole of the transfer device is formed in the shelf trays.

In a further advantageous embodiment of such a storage system according to the invention the transfer device of the picking station and/or the picking device has a drop shaft, a guide element and/or a slide chute on which piece goods can be transferred to the conveying device under the action of gravity.

In another advantageous embodiment of a storage system according to the invention the transfer device of the picking station and/or the picking device has a pre-sorting device configured to transfer piece goods, which have been transferred to the transfer device in a certain order, to the at least one conveying device in a certain different order.

Advantageously, in a storage system according to the invention the storage device of the picking facility is implemented as a vertically circumferential paternoster shelf storage, having a storage location transfer device designed as a paternoster conveyor with a plurality of shelf trays, on which piece goods and/or storage containers with piece goods can be placed, so that the storage location transfer device can convey the shelf trays along the various storage bays of the storage device.

In an alternative advantageous variant, in a storage system according to the invention the storage device of the picking facility is implemented as a shelf storage, having one or two shelf units, each including a plurality of storage bays disposed above one another. The storage location transfer device has a storage and retrieval machine configured to transfer a shelf tray from one storage bay to a different storage bay.

Advantageously, in such a storage system the storage device of the picking facility has two shelf units horizontally spaced apart from one another, and the storage and retrieval machine is disposed between the two shelf units.

Advantageously, in a storage system according to the invention the conveying device is configured to convey piece goods out of the picking facility.

Also advantageously, the conveying device is disposed below the picking locations of the picking station and/or the picking device.

Advantageously, a storage system according to the invention has a transfer device configured to convey piece goods placed in a drop hole of the transfer device to the at least one conveying device under the action of gravity; and a device configured to retrieve piece goods from a shelf tray and transfer it to the transfer device.

Particularly advantageously, the device for retrieving piece goods is designed as a manipulator device having a robot arm.

In an advantageous embodiment of a storage system according to the invention a picking device with a picking location is provided, wherein the picking device comprises a horizontal conveying device that is disposed on the picking location and onto which piece goods can be placed by a storage and retrieval machine of the picking facility; wherein the horizontal conveying device is configured to convey piece goods placed on the horizontal conveying device to a downstream processing station.

Particularly advantageously, the storage and retrieval machine of the picking facility has a manipulator device capable of placing piece goods onto the horizontal conveying device of the picking device.

In a further advantageous embodiment of a storage system according to the invention a picking device with a picking location is provided, wherein the picking device has a manipulator device configured to retrieve articles from a shelf tray on the picking location and transfer them to a conveying device.

Advantageously, in a storage system according to the invention a downstream processing station is provided, configured to transfer piece goods supplied by a conveying device from the picking facility to a downstream conveying system of the storage system.

Particularly advantageously, the downstream conveying system of the storage system is an overhead conveying system, in particular an overhead pouch conveying system.

Alternatively, or in addition, advantageously the processing station, or the picking device, respectively, has a manipulator device configured to retrieve articles from storage containers and transfer them to the downstream conveying system of the storage system, wherein the storage containers were supplied via the long-term storage.

Advantageously, the manipulator device is designed as a robot arm.

A fifth aspect of the invention relates to a storage system.

A storage system according to the invention comprises a long-term storage in the form of a crate stack storage device for storing a plurality of storage containers, in which piece goods can be stored, wherein the crate stack storage device has at least one storage and retrieval machine capable of retrieving, moving and placing storage containers within the crate stack storage device; a downstream conveying system; an automated picking device with a picking location, on which a storage and retrieval machine of the crate stack storage device can place one or more storage containers; and a processing station configured to transfer piece goods supplied by the automated picking device to the downstream conveying system of the storage system. The automated picking device has a manipulator device, for example a robot arm, configured to retrieve piece goods from a storage container on the picking location and directly transfer it to the processing station or to a belt conveyor of the automated picking device, which is connected to the processing station in terms of conveying.

Advantageously, in such one the downstream conveying system is an overhead conveying system, in particular an overhead pouch conveying system; and the processing station is a filling device for the overhead conveying system.

Alternatively, or in addition, advantageously in such a storage system the picking location of the automated picking device comprises at least one storage bay within a storage slot of the crate stack storage device.

In an advantageous embodiment of a storage system according to the invention the picking location of the automated picking device has a belt conveyor, wherein a storage and retrieval machine of the crate stack storage device can place one or more storage containers on the belt conveyor.

Advantageously, a storage system according to the invention has a picking facility connected to the long-term storage in terms of conveying. Further aspects of the present invention will also be apparent from the following description.

### BRIEF DESCRIPTION OF SEVERAL VIEWS OF THE DRAWINGS

For a better understanding of the present invention reference will be made to the drawings below. They show merely exemplary embodiments of the subject matter of the invention.

FIG. 1 schematically shows an embodiment of a storage system according to the invention.

FIG. 2 schematically shows a perspective view of a crate stack storage as known from the prior art.

FIG. 3 schematically shows a side view of a picking facility according to the invention with an upstream crate stack storage as shown in FIG. 2.

FIG. 4 schematically shows a side view of a picking facility according to the invention with an upstream shelf storage.

FIG. 5(a) schematically shows a possible embodiment of a picking facility according to the invention with a storage device designed as a tray storage having storage containers in cross-section.

FIG. 5(b) schematically shows a possible embodiment of a picking facility according to the invention with a storage device designed as a tray storage having storage containers in a top view of a storage bay with a shelf tray placed thereon.

FIG. 5(c) schematically shows a possible embodiment of a picking facility according to the invention with a storage device designed as a tray storage having storage containers in a detailed side view of some storage bays.

FIG. 6 shows a schematic cross-section of another possible embodiment of a picking facility according to the invention with a storage device designed as a tray storage having storage containers.

FIG. 7(a) shows a schematic cross-section of a further possible embodiment of a picking facility according to the invention with a storage device designed as a paternoster storage having storage containers.

FIG. 7(b) shows schematically a top view of the picking location of the shown picking facility.

FIG. 8(a) shows a schematic cross-section of yet another possible embodiment of a picking facility according to the invention with a storage device designed as a tray storage for storing piece goods.

FIG. 8(b) shows (b) schematically a top view of the picking location of the shown picking facility.

FIG. 9 schematically shows a front view of the picking station of a possible embodiment of a picking facility according to the invention having a conveying device disposed below the picking station.

FIG. 10 schematically shows a front view of the picking station of a further possible embodiment of a picking facility according to the invention having a conveying device disposed below the picking station.

FIG. 11(a) schematically shows a front view of the picking station of a possible embodiment of a picking facility according to the invention having a pre-sorting device and a downstream processing station.

FIG. 11(b) schematically shows a top view of a shelf tray having a drop hole.

FIG. 12 schematically shows a front view of the picking station of another possible embodiment of a picking facility according to the invention having a pre-sorting device and a downstream processing station.

FIG. 13 schematically shows a front view of the picking station of a further possible embodiment of a picking facility according to the invention having a pre-collecting device and a downstream processing station.

FIG. 14 schematically shows a cross-section of a possible embodiment of a picking facility according to the invention having an automated picking device.

FIG. 15 schematically shows a top view of another advantageous automated picking device of a picking facility according to the invention.

FIG. 16 schematically shows a front view of another possible embodiment of a picking facility according to the invention having an automated picking device.

FIG. 17 schematically shows a side view of another exemplary embodiment of a downstream processing station connected via the upstream storage device.

### DETAILED DESCRIPTION OF THE INVENTION

The exemplary embodiments set forth in the following description are intended to provide a better illustration of the invention, but are not suited to limit the invention to the features disclosed herein. Similar parts or parts with similar effects are designated by the same or similar reference numerals.

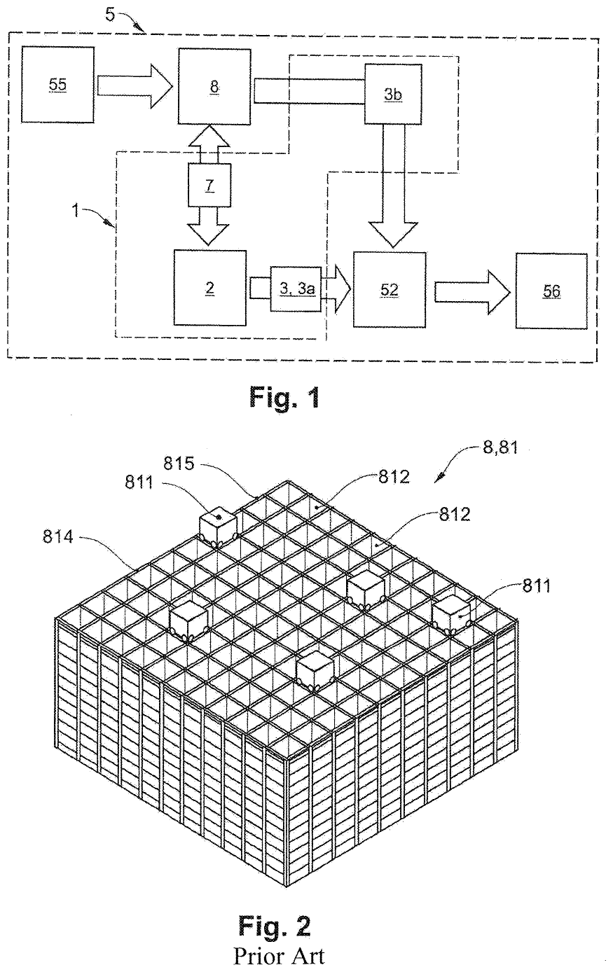

An embodiment of a storage system 5 according to the invention is schematically illustrated in FIG. 1. Such a storage system 5 comprises a long-term storage 8 upstream of a picking facility 1 according to the invention. New articles are supplied to the long-term storage 8 from an upstream goods input station 55.

The long-term storage 8 is intended for medium-term to long-term storage of articles, which requires a large storage capacity and, at the same time, a best possible use of space due to efficiency reasons. Even when fully automated, respective technological solutions for storage devices tend to have relatively long access times and limited access capacities. This means that when a set of certain articles (a picking order) is to be provided for further use, such as shipping to a customer or further processing in an industrial manufacturing process, this limited access speed and access capacity of the long-term storage 8 can lead to a bottleneck in terms of logistics In order to avoid this, a picking facility 1 according to the invention can be disposed downstream of the long-term storage 8. The picking facility 1 comprises a short-term storage 2 to which the required articles, preferably for multiple picking orders, can be supplied for storing in an efficient manner. Likewise, experience suggests that articles frequently required for picking orders in general can be held available in the picking facility 1 to reduce the number of access cases to the long-term storage 8.

The short-term storage 2 is intended to allow quick access to the articles required for compiling a picking order. Technological solutions for storage devices addressing these requirements usually provide limited storage capacity and use of space. Accordingly, a transfer interface 7 for transferring articles from the long-term storage 8 to the short-term storage 2 of the picking facility 1 must be designed to be as efficient as possible.

Compiling the total quantity or partial quantities of the articles for a picking order and their transfer from the picking facility 1 according to the invention to a downstream conveying system 52 of the storage system 5 is performed at one or more picking stations 3 and/or picking devices 3a, 3b of the picking facility 1 according to the invention.

Compiling and transferring the articles can be performed at the picking devices 3a, 3b in a fully automated manner. Transferring the articles to a downstream conveying system 52 can be performed directly 3, 3a or also via the conveying means of the long-term storage 8. Specific embodiment variants will be discussed in more detail below.

The conveying system 52 advances the articles, for example, to a goods output station 56 where they can be packaged and shipped to the intended recipient.

Various solutions for volume-efficient, fully automated long-term storages are known from the prior art, in particular high shelf storages with storage and retrieval machines disposed between the shelf units. In such high shelf storages all storage locations can be reached directly, so substantially the access times are a function of the required travel distances of the storage and retrieval machine. The achievable use of space is limited by the space requirements for the aisles between the shelf units, where it must be possible for the storage and retrieval machines to move horizontally and vertically.

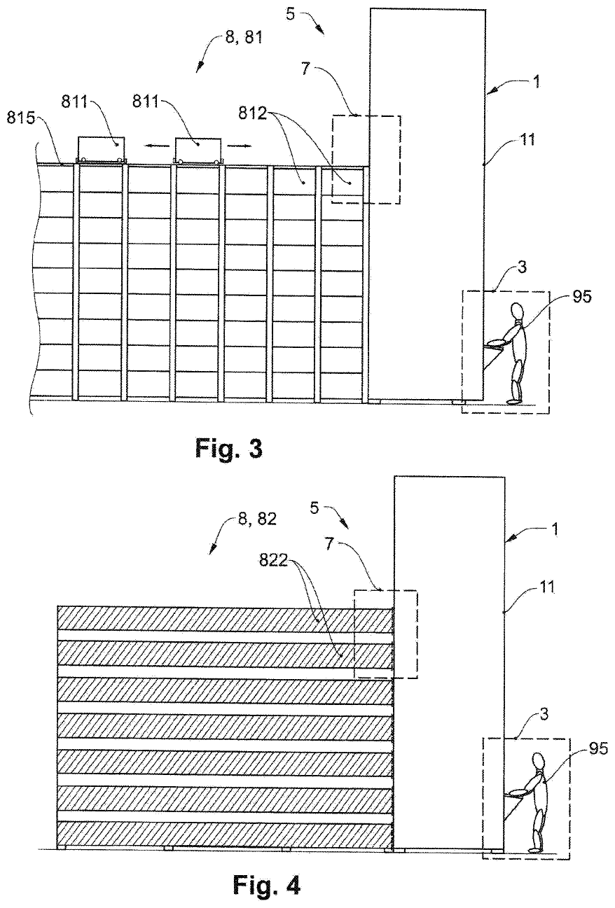

A particularly advantageous solution for use as a long-term storage 8 in a storage system 5 according to the invention are crate stack storage devices 81 as described, for example, in document WO 98/49075 A1 discussed above. Such a crate stack long-term storage 8, 81 according to the prior art is schematically illustrated in FIG. 2. The storage device 81 comprises a support structure 814 defining a grid of vertical storage slots 812. Appropriately dimensioned, standardized, stackable storage containers (not illustrated) can be stacked on top of one another in these storage slots 812. Preferably, the storage containers are open at the top. Such a storage device 81 allows obtaining a very good use of space as substantially the entire volume of the storage device 81, beside the transport plane 815, where the storage and retrieval machines 811 move, and the volume of the support structure 814, is available for the storage containers.

Handling the storage containers is performed by means of one or more storage and retrieval machines 811, which can travel horizontally along the axes of the grid on a transport plane 815 above the storage slots 812. The storage and retrieval machines 811 have a lifting crane device (not visible in the exemplary embodiment shown, disposed inside the housing of the storage and retrieval machine 811) capable of grasping the respective uppermost storage container of a storage stack in a storage slot 812 and pulling it up into the inside of the storage and retrieval machine 811. In an analogous manner, a storage container transported by a storage and retrieval machine 811 can be lowered into a storage slot 812 and placed onto an existing storage stack.

Access to the storage containers of a crate storage stack always follows the first-in last-out concept. When access to a certain storage container in the storage device 81 is desired, all storage containers in the crate storage stack including this storage container which are higher up in the stack must be removed by a storage and retrieval machine 811 before this certain storage container becomes accessible. Accordingly, the access times for the storage containers depend on their positions in the storage stacks. Advantageously, the more frequently storage containers need to be accessed the higher up in the storage stacks they are stored in order to thereby minimize the average access time.

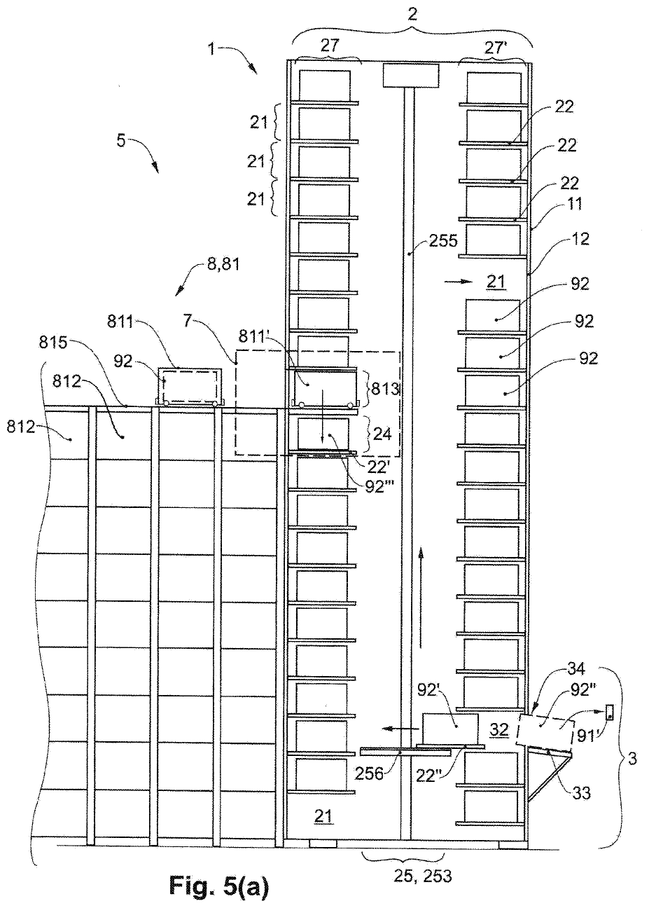

In such a long-term storage 8 in the form of a crate stack storage device 81, a picking facility 1 according to the invention is disposed downstream in a storage system 5 according to the invention, as schematically illustrated in FIG. 3. The picking facility 1 has a closed housing 11 and is directly fixed to a side of the crate stack storage device 81. Via a merely schematically shown transfer interface 7, storage containers from the long-term storage and/or articles in said storage containers are transferred to the short-term storage of the picking facility 1 and stored there for immediate or later use in compiling a picking order. At a picking station 3 an operator 95 can collect the articles of a picking order and provide them for later use in the storage system. Various specific implementations of such transfer interfaces 7 and such picking stations 3 will be discussed using the following figures.

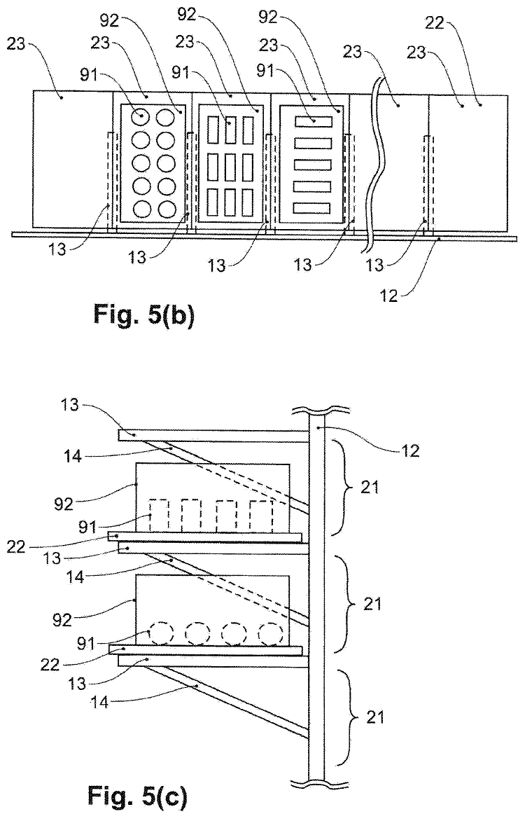

As a long-term storage 8 of a storage system 5, other storage devices can also be used, such as a high shelf storage in analogy to the initially discussed document DE 102021129397 B3. Such a high shelf storage system 82 having storage planes 822 disposed above one another and each using a separate storage and retrieval machine is shown in FIG. 4. Again, via an appropriately designed transfer interface 7 (illustrated schematically) storage containers from the long-term storage and/or articles in said storage containers are transferred to the short-term storage of the picking facility 1 fixed thereto.

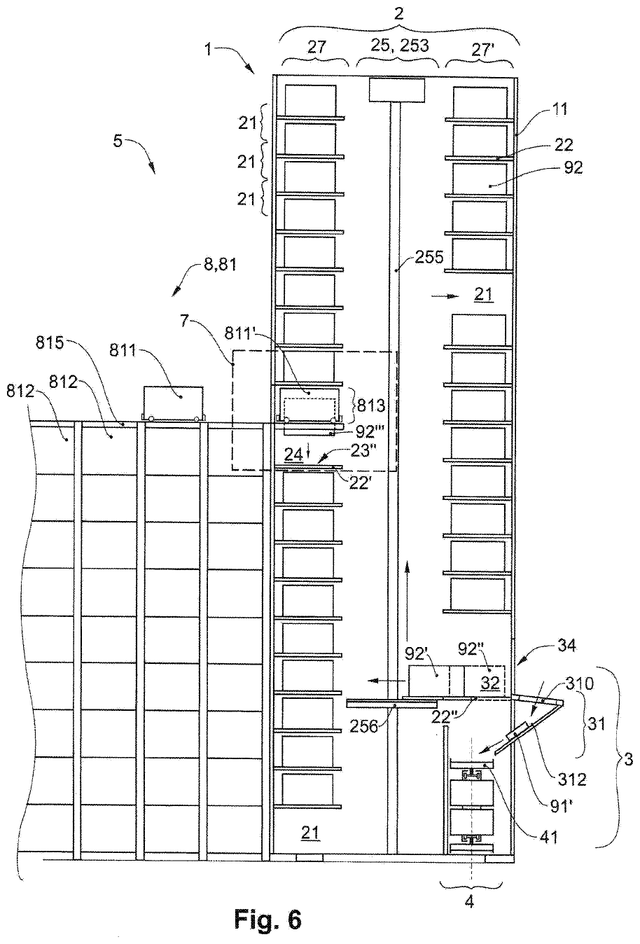

A specific design of a picking facility 1 according to the invention as part of a storage system 5 according to the invention having an upstream crate stack storage device 81 as a long-term storage 8 is explained below using FIG. 5(a)-(c).

The picking facility 1 comprises a short-term storage device 2 in the form of a shelf storage 27, 27′. On a support structure 12 disposed within a housing 11, multiple storage bays 21 disposed above one another are provided at two longitudinal sides. Shelf trays 22 can be placed in these storage bays 21. Each shelf tray 22 has a plurality of n storage locations 23 for storage containers 92 of the long-term storage 8 in the longitudinal direction.

The shelf trays 22 are placed in the storage bays 21 on carrying structures 13, 14 connected to the support structure 12. Such carrying structures can be designed as horizontal booms 13 with support struts 14, for example, as shown in FIG. 5(b) and 5(c). They are disposed such that each of them is positioned between the storage containers 92 placed on the storage locations 23 of the shelf trays 22. Here, the number of the carrying structures 13, 14 is mainly dependent on the length of the shelf trays 22 and the maximum load capacity.

Between the two rows 27, 27′ of storage bays 21 of the storage device, a storage location transfer device 25 is provided in the form of a storage and retrieval machine 253. The storage and retrieval machine 253 is designed such that it can retrieve a shelf tray 22 including the storage containers 92 stored thereon in any storage bay 21 and can place it again in any other empty storage bay 21.

In a possible embodiment the storage and retrieval machine 253 can have vertical conveying devices 255 disposed at the longitudinal ends of the picking facility 1, capable of moving a horizontal platform 256 along the vertical direction. Means for lifting a shelf tray 22 in a storage bay 21 off of the carrying structures 13, 14 and moving it to a position between the two shelf rows are provided on the horizontal platform. Subsequently, the horizontal platform 256 can be moved to a new position in the vertical direction, where next the shelf tray 22 is placed in a different storage bay 21 on the carrying structures 13, 14.

The transfer of storage containers 92 between the long-term storage 8, 81 and the short-term storage 2 of the picking facility 1 is performed at a transfer interface 7. In the illustrated picking facility 1, for this purpose the horizontal transport plane 815 of the crate stack storage device 81 is extended into the inside of the picking facility 1 such that a storage and retrieval machine 811′ can be positioned on a transfer location 813 within the picking facility 1. Here, the number of the transfer locations is equal to the number n of the storage locations in the longitudinal direction of the storage device 2

The storage bay below the transfer locations 813 of the transport plane 815 is provided as a transfer storage bay 24 on which a shelf tray 22′ is placed. The n transfer locations 813 are disposed such that a storage and retrieval machine 811′ can place a storage container 92″ taken from the long-term storage 8, 81 on an empty storage location therebelow of the shelf tray 22′ in the transfer storage bay 24. As an advantageous result, the lateral distance of the storage locations 23 on the shelf trays 22 of the picking facility 1 is equal to the distance in the grid of the crate stack storage device 81.

In an analogous manner, a storage and retrieval machine 811′ can receive, at transfer location 813, a storage container 92″′ placed on the storage location therebelow of the shelf tray 22′ in the transfer storage bay 24. When required, the shelf tray 22′ in the transfer bay 24 can be replaced by a different shelf tray, for example when all storage locations of the shelf tray 22′ in the transfer storage bay 24 are occupied.

Advantageously, identification units are provided, allowing the identity of a storage container 92″′ before or after placing or retrieving the storage container by the storage and retrieval machine 811′, for example as a camera or barcode scanner capable of reading a respective unique optical marker of a storage container. This enables a master control unit to compare the current state to the target state in order to avoid problems and error states, such as missing or incorrect storage containers, or detect them early.

In the illustrated short-time storage device 2 of the picking facility 1 at least one storage bay 21 must be vacant to allow moving a shelf tray from each storage bay to any other storage bay, optionally in two steps. Advantageously, in order to increase efficiency of the storage device, two or more storage bays are vacant, for example in order to keep transport distances of the shelf trays short or allow proactive moving of shelf trays.

The storage and retrieval machine 253 is provided to transfer entire shelf trays between the storage bays 21 of the short-term storage 2. However, as part of an efficient management of the short-term storage and the picking orders to be completed, it can also make sense to move storage containers on a shelf tray from one storage location to a different storage location or from one shelf tray to a different shelf tray. For this purpose, the storage and retrieval machines 811, 811′ of the crate storage device 81 can be employed at the transfer interface 7. Removing storage containers 92 from the short-term storage 2, in particular completely empty storage containers, is also done via the transfer interface 7.

A picking station 3 is provided at the longitudinal side of the picking facility 1 facing away from the long-term storage 8, 81. In the exemplary embodiment illustrated the picking station 3 comprises a storage bay of the storage device 2 provided as a picking location 32. It is located at the working level of an operator (not illustrated). An access opening 34 in the wall of the housing 11 allows an operator to pull out a storage container 92″ (illustrated by a dashed line) from a shelf tray 22″ placed on the picking location 32 to the outside onto a placing surface 33. The operator can now retrieve the article 91′ required for a picking order from the respective storage container 92″ and place it on a conveying device (not illustrated) provided outside of the picking facility 1 or in a collector provided for the picking order, for example.

When the respective storage container 92″ is no longer needed, it will be pushed back to the storage location of the shelf tray 22″ on the picking location 32 by the operator. When finally all required articles are retrieved from the respective storage containers of the shelf tray 22″ on the picking location 32, the shelf tray 22″ is removed via the storage location transfer device 25 and replaced by a different shelf tray.

A computer-or microprocessor-controlled control unit (not illustrated) of the picking facility 1 controls the various elements of the storage device 2, in particular the storage location transfer device 25, 253. Advantageously, the control unit is configured to receive a series of picking orders to be completed and manage the storage containers stored in the storage device 2 accordingly. With the aim of managing the picking orders as efficiently as possible, the control unit can request storage containers including articles required for the picking at a control unit (not illustrated) of the upstream long-term storage 8, 8a and have them placed at the corresponding storage locations 23 of the best-suited shelf trays 22 in order to later move them to the picking location 32 of the picking station 3 via the storage location transfer device 25, 253.

Preferably, the control unit has an optimizing module capable of calculating the optimal occupation and management of the storage device 2 and the optimal order of processing the picking orders on the basis of the current occupation of the storage device 2, the present picking orders and the current status information of the long-term storage 8 and the main storage system 5. Advantageously, external parameters such as the work schedules of the operators also taken into account. For example, if the operators are working in two shifts to operate the picking facility 1, the picking facility 1 can optimize the occupation of the storage device and also already prepare the articles for picking orders to be processed later in an optimal manner during times when no picking orders can be completed due to a lack of operators on site.

The control unit can also be designed as part of a master control unit. For example, the control units of the long-term storage 8 and of the picking facility 1 can be designed as a shared control unit.

Instead of one shelf tray, a storage device 2 can also have two or more shelf trays, each with multiple storage locations, disposed adjacent to one another in a storage bay. Such an embodiment variant allows a more flexible management of the storage device as the shelf trays at the transfer interface can be loaded with storage containers faster and/or the shelf trays can be retrieved back from the picking device faster. On the other hand, the storage location transfer device 25 becomes more sophisticated and more complex.

The exemplary embodiment of a picking facility 1 according to the invention discussed above allows providing the articles for a picking order in a very efficient manner. However, further processing of the articles, in particular compiling the articles of a picking order and advancing them, is performed outside of the picking facility 1.

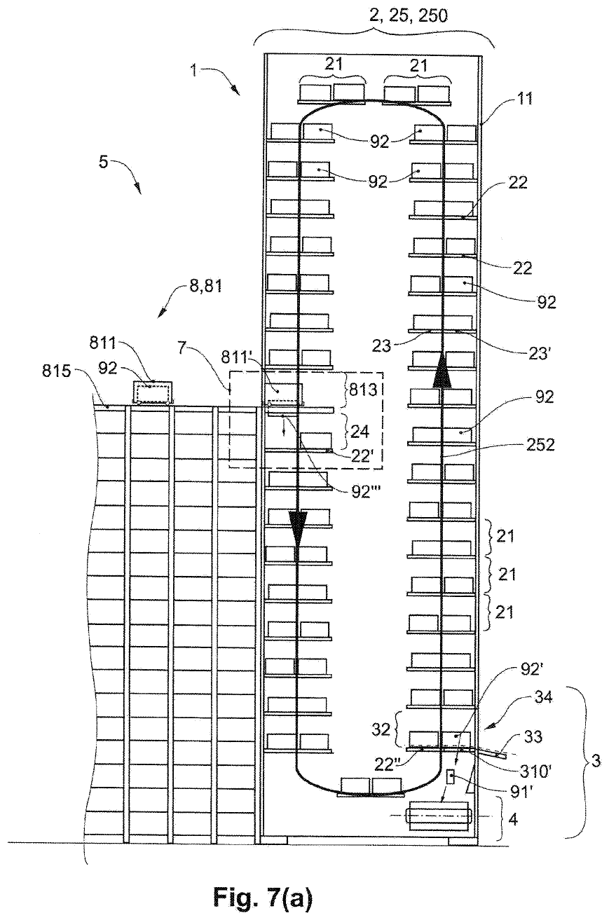

The efficiency of the entire picking process can be further increased by integrating these working steps into the picking facility according to the invention. Such an exemplary embodiment is illustrated in FIG. 6.

Again, the picking facility 1 according to the invention has an upstream long-term storage 8 in the form of a crate stack storage 81 connected to the short-term storage 2 of the picking facility 1 via a transfer interface 7. In FIG. 6 shown, a storage and retrieval machine 811′ positioned on the transfer location 813 of the transport plane 815 places a storage container 92″ on a storage location 23″ therebelow of a shelf tray 22′ placed in the transfer storage bay 24.

The picking station 3 comprises a storage bay provided as a picking location 32 in which a shelf tray 22″ with a plurality of storage containers 92″ can be placed. Instead of a storage bay, a free volume is provided directly above the picking location 32. The access opening 34 can be designed correspondingly higher and allows an operator to look into the storage containers 92″ open at the top. Optionally, mirrors and lighting means can also be provided to facilitate looking into the picking facility 1 from the outside.

A horizontal conveying device 4 is provided below the picking location 32, in the exemplary embodiment shown in the form of a circumferential tilt tray conveyor having a high number of tilt trays 41 disposed along a circumferential conveying path. Alternative horizontal conveyors, in particular belt conveyors and modular belt conveyors, can also be used.

An operator (not illustrated) can now retrieve one or more articles 91′ required for a picking order from the respective storage container 92″ and transfer them to a transfer device 31. The transfer device 31 comprises a drop hole 310 and a slide chute 312 therebelow, on which the dropped articles 91′ slide onto a tilt tray 41 of the conveying device 4 under the action of gravity.

Advantageously, the transfer device is disposed centrally in the longitudinal direction with respect to the picking station 3 so that the average walking distances of an operator from a storage container including the required articles to the drop hole 310 are as short as possible.

Advantageously, sensors registering the occupation of a tilt tray by the dropped articles 91′ can be provided. The conveying device 4 can then be advanced by one position so that an empty tilt tray 41 for the next article is ready below the transfer device 31 again.

The completed articles of a picking order collected on the tilt tray conveyor 4 can subsequently be advanced for further processing. For example, they can be transferred to a downstream conveying system of a main storage system, which conveys them to a goods output station, or to a production facility where the articles of the picking order are needed.

In particular, the completed articles of a picking order collected on the tilt tray conveyor 4 can be transferred to an overhead conveying system by putting the articles into an overhead conveying pouch of an overhead conveying system.

Advantageously, in an embodiment of a picking facility according to the invention where two separate shelf trays are disposed adjacent to one another in each storage bay, the transfer device is disposed where the two shelf trays meet.

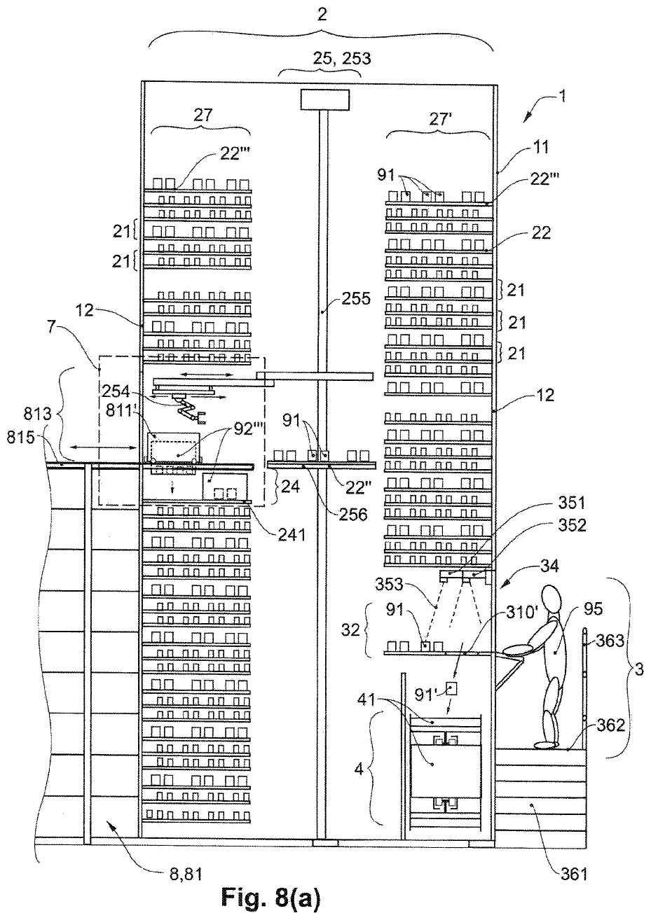

Alternatively, the short-term storage 2 of a picking facility 1 according to the invention can be designed as a paternoster shelf 250 as in the exemplary embodiment of a picking facility 1 illustrated in FIG. 7(a) and 7(b). In a paternoster storage 250 the functions of the storage device 2 coincide with those of the storage location transfer device 25 in the form of a paternoster conveyor. For this purpose, a paternoster conveying device has a plurality of shelf trays 22 disposed in moveable fashion along a circumferential conveying path 252. Along the conveying path 252, static storage bays 21 are defined, in this case having a primarily functional meaning as a location identifier. The paternoster conveying device 250 conveys the shelf trays 22 along the conveying path 252 from one storage bay 21 to the next one.

Various ways for designing such a paternoster conveying device are known to those skilled in the art. For example, a coupling to two parallel circumferential drive chains of the conveyor can be provided at two opposing corners at the two longitudinal ends of a shelf tray, thus defining the conveying path. At the respective other corners of the shelf tray, rollers can be provided, moving in respective slotted guides and thus guaranteeing a permanently horizontal orientation of the shelf trays 22.

In order to convey shelf trays 22 of the storage device 2 towards or away from the picking location 32 and in order to convey shelf trays 22 towards or away from the transfer interface 7, the paternoster conveying device 250 advances the entirety of the shelf trays 22 along the conveying path 252 in a conveying direction (indicated by the bold arrow) by the required number of storage bays. The conveying direction can always be the same. Advantageously, however, the conveying direction is selected accordingly as needed so the operation of the picking facility 1 as a whole can be as efficient as possible.

In the exemplary embodiment shown, two rows of storage locations 23, 23′ for storage containers 92 are provided on each shelf tray 22 in the longitudinal direction, wherein in one of the two rows one storage location on a side of the shelf tray remains vacant at all times. At this location a hole 310′, which will be discussed in more detail below, is provided in the shelf tray 22.

Disposing two rows of storage locations 23, 23′ on the shelf trays 22 allows a higher storage capacity of the short-term storage device 2. However, it is also possible to provide only one row of storage locations. In an analogous manner, in the picking facilities with individually moveable shelf trays discussed above, the shelf trays can also be provided with two rows of storage locations.

The transfer of storage containers 92 between the long-term storage 8 designed as a crate stack storage device 81 and the short-term storage 2 of the picking facility 1 is performed via an analogous transfer interface 7 as in the exemplary embodiments already discussed. In this specific case, on the transport plane 815 two transfer locations 813 are provided, on which a storage and retrieval machine 811′ of the long-term storage 8 can place a storage container onto a storage location 23″ therebelow of a shelf tray 22′.

At the picking station 3, an operator (not illustrated) can pull out a storage container 92′ on a storage location 23′ of the shelf tray located at the picking location 32 through an access opening 34 to a placing surface 33 in order to gain access to the articles 91 in the storage container 92. Alternatively, the operator can also access the storage container 92′ directly. When the operator needs to have access to a storage container placed on a storage location 23 in the rear row of the shelf tray 22′, she can first pull the front storage container 23′ of the front row to the placing surface 33 and then pull the rear storage container to the front storage location 23′.

A conveying device 4 in the form of a circumferential modular belt conveyor is disposed below the picking location 32. In order to place an article 91′ of a picking order retrieved from a storage container 92′ on this horizontal conveying device 4, the operator drops the article 91′ through the central drop hole 310′ of the shelf tray.

In an advantageous variant, guide elements, for example in the form of vertical guide plates or elastic plastics elements, are disposed below the drop hole 310′ of each shelf tray 22 to guarantee safe placement of an article 91′ on the conveying device 4.

Disposing the drop hole 310′ on the shelf tray 22 has the advantage of maintaining a compact exterior of the picking station 3. However, shelf trays having such central drop holes can also be used in storage devices having moveable shelf trays.

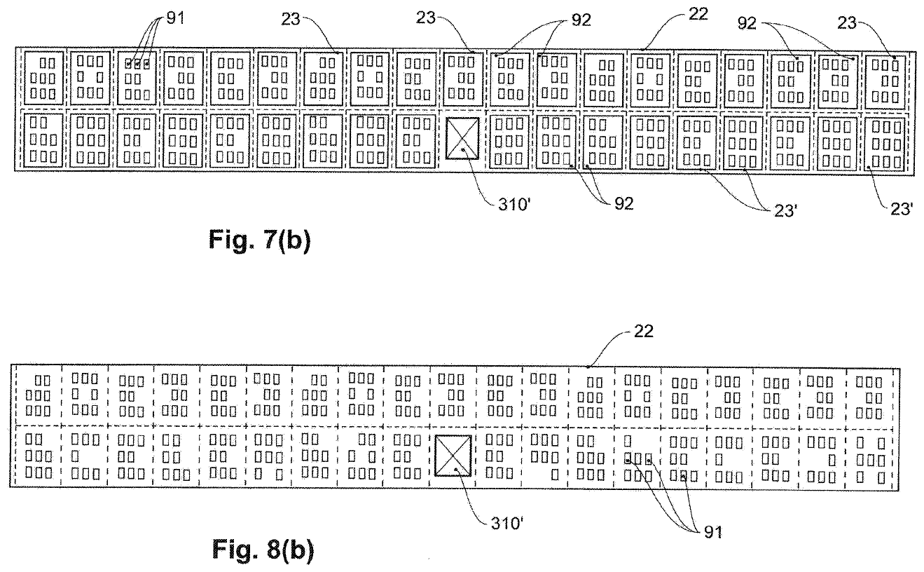

Such an advantageous embodiment of a picking facility 1 according to the invention is discussed with reference to FIG. 8(a) and 8(b). The picking facility 1 is connected to an upstream crate stack storage device 81 as a long-term storage 8 via a transfer interface 7. The short-term storage 2 of the picking facility 1 is designed as a shelf storage device 27, 27′ having a high number of shelf trays 22 stored at two sides of the housing 11 in storage bays 21 on carrying structures (not illustrated).

In contrast to the embodiments discussed above, in this case the articles 91 in the storage device 2 are stored directly on the shelf trays 22 and not in storage containers 91. This allows a higher efficiency in terms of volume of the short-term storage 2 as, in particular, the individual storage bays 21 can be of lower height and also a higher occupation rate of the shelf trays 22 can be achieved. The storage bays 21 can be designed to have different heights. Depending on the maximum height of the articles 91 stored on a shelf tray 22, a shelf tray 22 can be placed in a storage bay 21 just sufficiently high in order to further minimize the required storage volume.

In the transfer interface 7 the transport plane 815 of the long-term storage 8, 81 is extended into the interior of the picking facility 1 in such a way that two transfer locations 813, one behind the other, are available for the storage and retrieval machines 811′. Advantageously, as many n transfer locations as possible are provided in the longitudinal direction of the picking facility 1 adjacent to one another. At these 2*n transfer locations the storage and retrieval machines 811′ can place a storage container 92″ in the transfer storage bay 24 therebelow onto a stationary transfer shelf tray 241. Using a manipulator device 254, for example with a robot gripping arm moveable transversely to the shelf as shown, some or all articles 91 in the storage containers 92″ placed in the transfer bay 24 can be retrieved and transferred to a shelf tray 22″ held available by the storage location transfer device 25. For this purpose, the manipulator device 254 is movable also in the longitudinal direction of the shelf storage so that an article can be placed at any location of the shelf tray 22″.

Empty or partially empty storage containers 92″ that are no longer needed can then be returned from the transfer bay 24 to the long-term storage 8, 81 by the storage and retrieval machines 811′ for further use. Since other than that no storage containers 92 must be returned from the storage device 2 to the long-term storage 8, fewer relocation processes of the storage location transfer device 25 are required, in particular.

In the illustrated embodiment, the manipulator device 254 is disposed above the platform 256 as part of the storage and retrieval machine 25, 253. Accordingly, sufficient space towards the top is required for the manipulator device 254 at the height of the uppermost storage bay. The manipulator device 254 can also be used to relocate articles on the uppermost shelf trays 22″′, for example in order to optimize the load of the respective shelf trays 22″′ or to transfer articles from the transported shelf tray 22′ to the uppermost shelf trays 22″′.

In an alternative embodiment, the manipulator device 254 can be designed such that it can be moved in the vertical direction independently from the platform 256. This allows a more flexible and more efficient operation of the storage location transfer device 25 as the two functions can be decoupled.

In another alternative embodiment, the manipulator device 254 can be attached to the lateral support structure 12 of the picking facility 1.

A picking location 32 is provided with the picking station 3 of the picking facility 1, where a shelf tray 22′ can be placed on carrying structures (not illustrated) by the storage location transfer device 25. An operator 95 can view and access the articles 91 on the shelf tray 22′ via an access opening 34.

Each shelf tray 22 has a drop hole 310′ in a central region, which is not available for storing articles 91. When the shelf tray 22′ is located at the picking location 32, an operator 95 can drop an article 91′ through this drop hole 310′ onto a conveying device 4 therebelow, in the example shown onto a provided transport tray 41 of a tray conveyor.

An indicator unit 351 indicates to the operator 95 which article 91 needs to be dropped into the drop hole 310′ next. For example, this can be achieved by means of a light pointer 353, which might be generated by a guidable laser beam. Above the drop hole 310′, an identification unit 352 is provided, for example in the form of a camera or a laser scanner, or in the form of an RFID reader unit. Before the operator 95 drops an article 91′ into the drop hole 310, she has it identified by the identification unit 352, for example by reading a barcode. A positive identification can then be provided to the operator via an audible and/or optical signal, i.e., the identified article is the same as the actually required article.

Due to its larger deflection radius, the tray conveyor 4, as shown in FIG. 8(a), has a higher construction height than a belt conveyor, for example, so the picking location 32 must be disposed higher. Thus, in order to guarantee an ergonomic working level, a working platform 362, having a guardrail 363 at the rear side and being accessible via stairs 361, is provided in the region of the access opening.

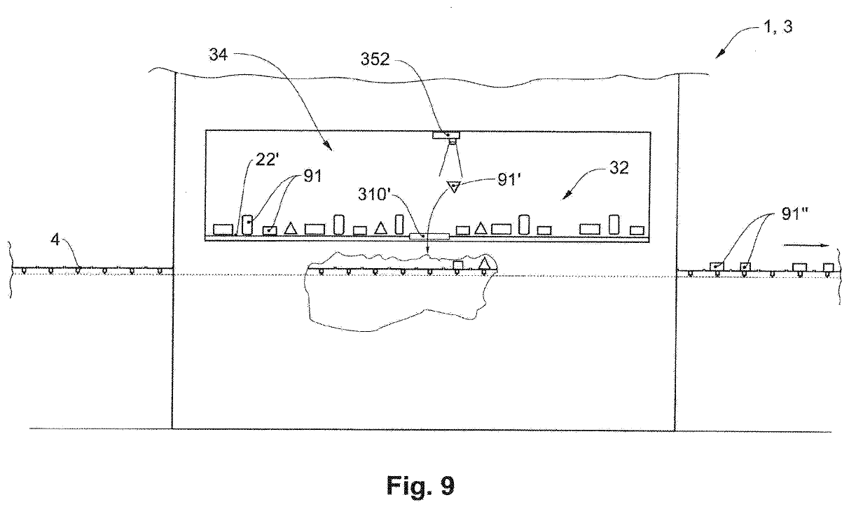

A further embodiment of a picking facility 1 according to the invention is shown in a section in FIG. 9, with a view of the access opening 34 of the picking station 3 of the picking facility 1. The upstream long-term storage, which is located behind the picking facility 1 in the viewing direction, is not visible.

The storage device of the picking facility 1 is designed as a shelf storage in an analogous manner to the picking facility in FIG. 8(a). On the picking location 32 there is a shelf tray 22′ on which a high number of articles 91 is placed. In the center with respect to the longitudinal side of the shelf tray 22′, a drop hole 310′ is provided towards the access opening 34 in the shelf tray 22′ in an analogous manner to FIG. 8(b).

The conveying device 4 is designed as a horizontal modular belt conveyor, which enters the housing 11 of the picking facility 1 coming from the left in an empty state, then moves beyond the drop hole 310′ below the shelf tray 22′ at the picking location 32 and leaves the picking facility again moving further to the right, in order to transport the articles of a picking order collected in this way to further processing (not illustrated).

An operator (not illustrated) can retrieve an article 91′ needed to complete a picking order from the shelf tray 22′, have it identified by an identification unit 352 (for example a camera-Based based system for reading a barcode or QR code) and then drop it through the drop hole 310′ in the shelf tray 22′ onto the horizontal conveyor 4 or also place it thereon manually.

Advantageously, below the drop hole 310′ of the shelf tray 22′ a light barrier sensor (not illustrated) can be provided, capable of registering the passing of an article. Furthermore, a camera system can also be provided, capable of verifying the position and/or identity of an article dropped onto the conveyor 4.

In the exemplary embodiment shown, the vertical distance between the horizontal conveyor 4 and the shelf tray 22′ is smaller than in the picking facility according to FIG. 8(a) discussed above. This allows manual placing on the conveying device or at least reduces the falling distance of an article 91′.

As the continuous horizontal conveyor 4 requires little space in the vertical direction, the picking station 3 can be designed such that an operator can operate the picking station 3 at ground level. Reversing the belt conveyor is performed via a horizontal path not illustrated, so such an embodiment becomes particularly advantageous for longer and/or horizontally bent transport paths of the articles.

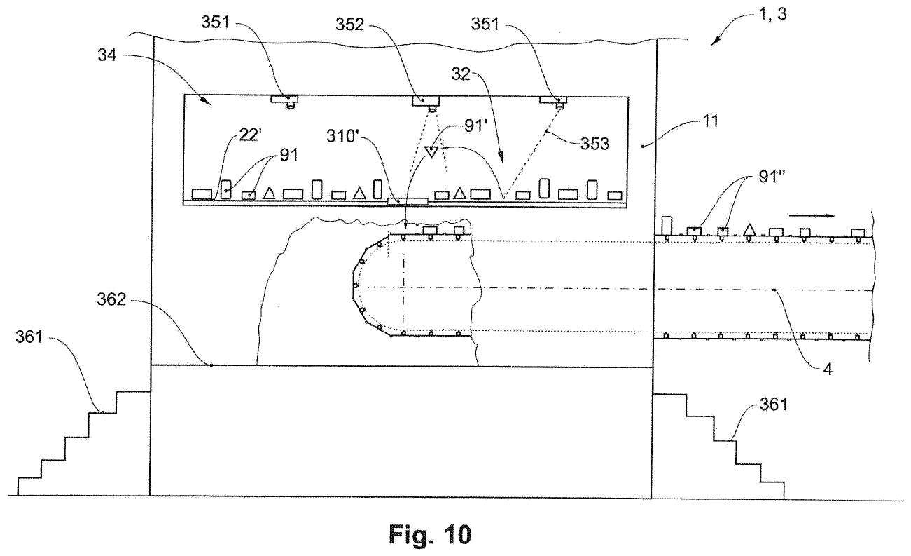

However, when the conveying device 4 is designed as a circumferential horizontal modular belt conveyor with a larger construction height, as disclosed as an example in FIG. 10, a working platform 362 might be required to grant ergonomic access to the access opening of the picking station for an operator.

Above the picking location 32, two indicator units 351 are provided, capable of optically indicating to an operator which article 91′ should be retrieved next from the shelf tray 22′. In the example shown, the right indicator unit 351 marks an article 91′ by a laser beam or a narrow light cone 353, which is directed onto the respective article. Such an optical marking increases the turnover speed as the operator can keep focused on the shelf tray 22′ instead of having to periodically read instructions from a screen, for example.

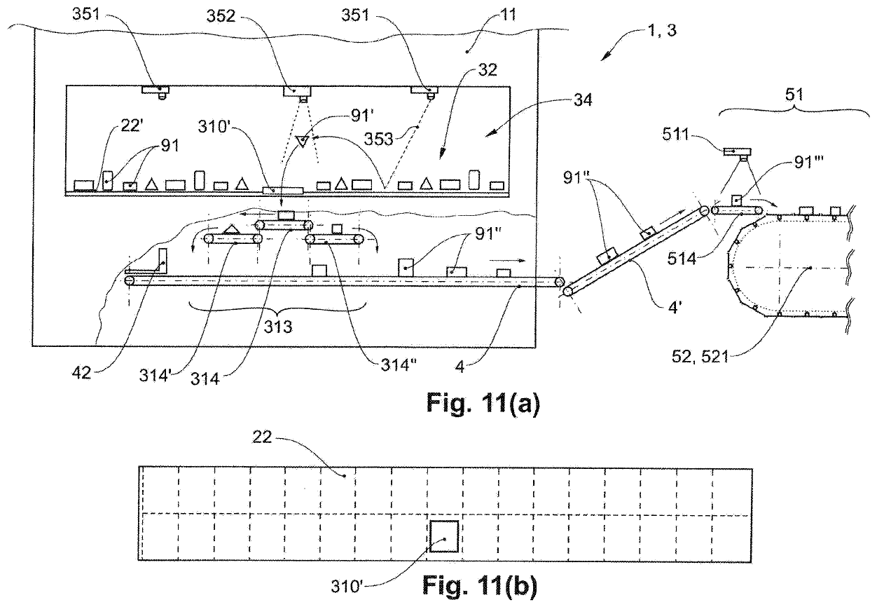

Advantageously, a picking facility 1 according to the invention can also be equipped with means 313, which allow pre-sorting and/or exact positioning of the transferred articles on the conveying device 4. Such an embodiment of a picking facility 1 according to the invention is shown as an example in FIG. 11(a) and 11(b). Above the picking location 32 the picking station 3 is the same as in the exemplary embodiment in FIG. 10.

Below the shelf tray 22′ on the picking location 32, a first circumferential horizontal belt conveyor 4 is disposed, which conveys articles 91″ to the right, where the articles end up on a second, inclined circumferential belt conveyor 4′. The second belt conveyor 4′ advances the articles 91″ to a downstream processing station 51.

At the processing station 51, a belt conveyor 514 accepts an article 91″′ and positions it below an identification unit 511, which can determine and/or verify the identity of the article 91″′ by optical means, in particular by reading a QR code or other optically readable information. Subsequently, the belt conveyor 514 transfers the article to a conveying system 52 in the form of a circumferential modular belt conveyor 521, which advances the articles.

Before an article 91′ previously identified by the identification unit 352 and then dropped through the drop hole 310′ in the shelf tray 22′ reaches the first conveyor 4, each such article 91′ first reaches a first sorting belt conveyor 314, which then advances the article according to the instructions of a control unit either to the left or to the right onto one of the two downstream sorting belt conveyors 314′, 314″. These second sorting belt conveyors 314′, 314″ can then place the article at a desired position of the horizontal first conveyor 4. Here, a restriction element 42 prevents an article from sliding too far to the back on the conveyor 4.

The sorting belt conveyors 314, 314′, 314″ together form a pre-sorting device 313, which allows placing a certain article on the conveyor 4 between two other, already placed articles. In this way, a sequence of articles on the conveyor 4 can be generated to a certain extent. Such an order sorting of articles can be useful, for example, for arranging the elements of a picking order in a certain order when necessary.

However, order sorting can also be useful, for example, for making the transfer of articles onto the conveyor 4 more efficient. For example, an indicator unit 351 can also mark two or more articles for transfer instead of just one, where it can be up to the operator to decide in which order to transfer the articles to the transfer device. A pre-sorting device allows correcting such a random order of transfer.

Advantageously, the circumferential first belt conveyor 4 is also integrated into the pre-sorting device 313 by decidedly stopping the belt conveyor 4 or moving it to the left or to the right by a certain distance.

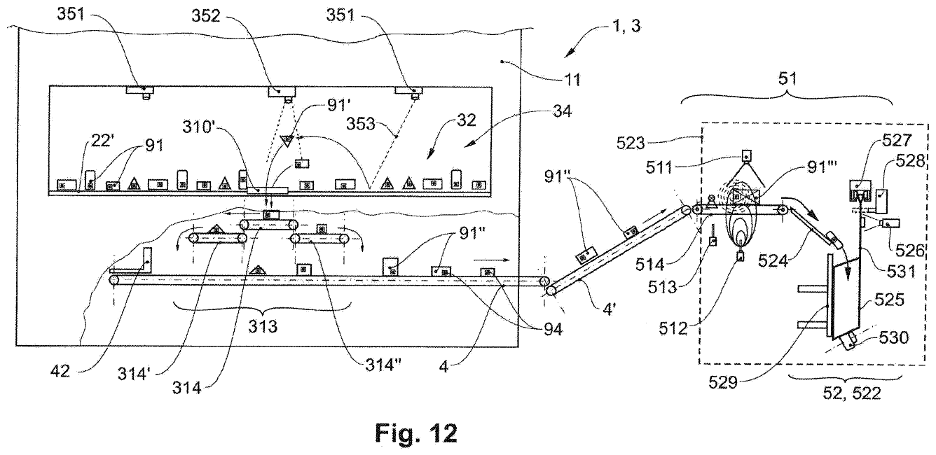

A similar embodiment of a picking facility 1 according to the invention is explained with reference to FIG. 12. The picking station 3 comprises a pre-sorting device 313 analogous to the preceding FIG. 11. Via the conveying device 4, 4′, the pre-sorted articles 91″ reach a post-processing station 51, which verifies the identity of the individual articles and transfers them to a downstream conveying system 52 in the form of an overhead conveying system 522. Such an overhead conveying system is known from US 2019/0367282 A1, for example.

At the post-processing station 51, a belt conveyor 514 accepts an article 91″′ and positions it below an optical identification unit 511. In addition, the post-processing station 51 has an RFID transmitter 513 and an RFID receiver 512 capable of reading a corresponding RFID tag 94 on the article 91″′.

The overhead conveying system 522 shown comprises a transport rail 527, in which a free-running carriage of an overhead conveying unit 531 is moveable in rolling or sliding fashion. The overhead conveying unit further comprises a transport pouch 525, which can be transferred into an open state by lifting the rigid bottom of the pouch.

For filling, the overhead conveying units 531 are conveyed to the required position. and temporarily its transport pouches 525 are oriented transversely to the conveying direction. The transport pouches 525 are opened by support rollers 530 during conveying, as shown in FIG. 12. Here, a stopper plate 529 stabilizes the overhead-supported transport pouch 525 and prevents it from swinging transversely to the conveying direction. A stopper element 528 stops the overhead conveying element 531 temporarily, and a scanner unit 526 identifies the overhead conveying element 531. Once an article 91″′ is identified, the belt conveyor 514 of the post-processing station 51 transfers the article to a slide chute 524 of the filling device 523, on which the article slides into the open transport pouch 525 of the provided overhead conveying unit 531. In an associated database of a control system of the conveying system 52, the article is now recorded as the load of the overhead conveying unit.

Single articles or also multiple articles can be loaded into a transport pouch 525. Once all intended articles are placed in the transport pouch 525, it is released again by the stopper element 528 to be advanced to a certain destination in the conveying system 52, 522, for example to a goods output station.

Provided that transport capacity allows it, the transport pouch 525 can be loaded with all articles of a picking order, for example. Alternatively, the articles of a picking order can also be distributed into multiple transport pouches. In this case, a transport pouch is loaded with only a partial quantity of the articles of a picking order, maybe even with only a single article of the picking order.

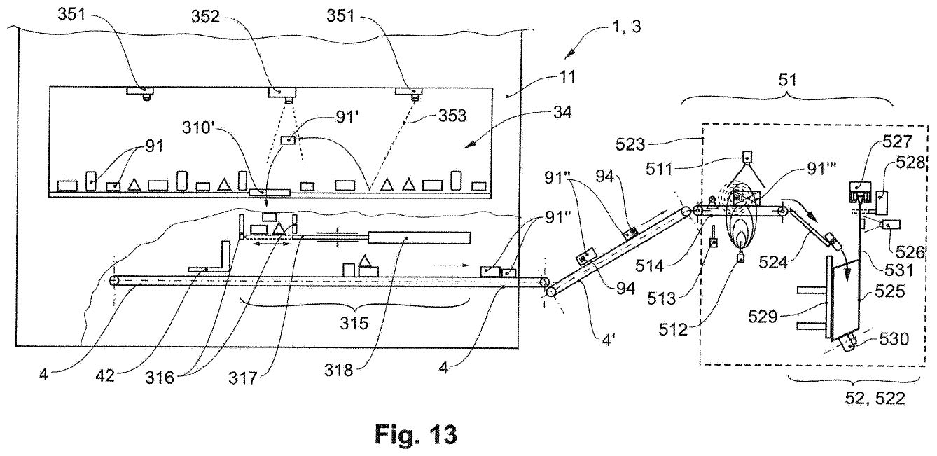

A further embodiment variant of a picking facility 1 according to the invention is disclosed in FIG. 13. The picking station 3 is different with respect to the preceding FIG. 12 because of a pre-collecting device 315, which is disposed below the drop hole 310′. The pre-collecting device 315 comprises a collector 316 having a moveably supported sliding bottom 317. The sliding bottom 317 is operatively connected to an actuator 318, which can be designed as a pneumatic or electric actuator, for example.

In a collecting configuration of the pre-collecting device 315, the sliding bottom 317 closes the bottom of the collector 316. Thus, articles 91′ dropped into the drop hole 310′ by an operator will first end up in the collector 316, as shown in FIG. 13. When finally all articles of a certain picking order are in the collector 316, or a partial quantity thereof (for example with larger picking orders), a control unit of the picking facility instructs the actuator device 318 to pull back the sliding bottom. I n this unloading configuration, the articles collected in the container 316 will now drop onto the belt conveyor 4 disposed therebelow and are conveyed to the downstream processing station 51 together. The downstream processing station 51 and the filling device 523 for the overhead conveying system 52, 522 are identical to FIG. 12. Accordingly, reference is made to the explanations there.

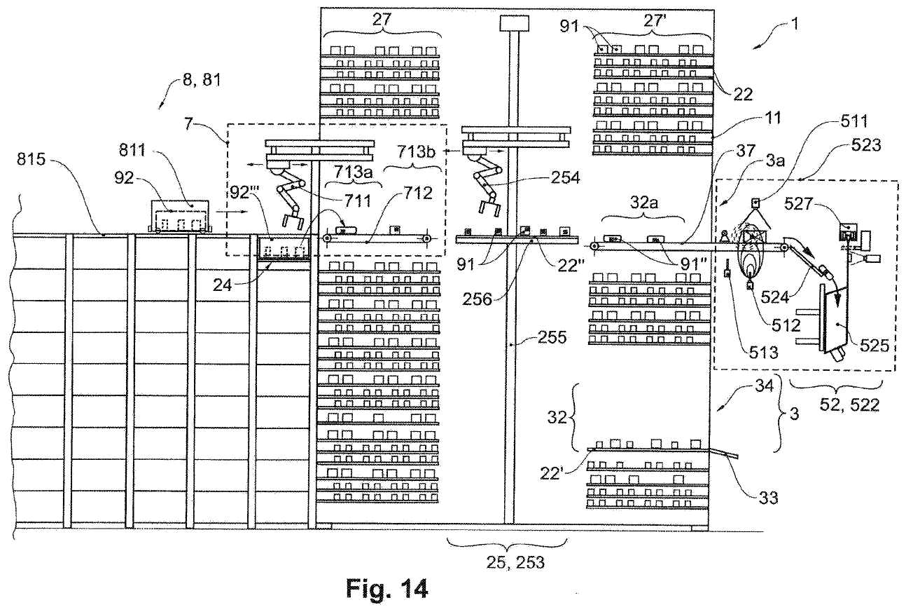

In order to achieve an even higher degree of automation for a picking facility according to the invention, it can be desirable to also automate the compiling of the articles of a picking order. Such an advantageous embodiment of a picking facility 1 according to the invention is to be explained by means of FIG. 14.

The picking facility 1 is connected to an upstream crate stack storage device 81 as a long-term storage 8 via a transfer interface 7. The short-term storage 2 of the picking facility 1 is designed as a shelf storage device 27, 27′ in analogy to FIG. 8(a).

The transfer interface 7 has a manipulator device 711 in the form of a robot gripping arm, moveable transversely to the shelf, and is configured to retrieve articles from a storage container 92″′ in a transfer storage bay 24 and place them on the housing-side half 713a of a belt conveyor 712. In addition, the manipulator device 711 is also moveable along the longitudinal axis of the shelf storage of the picking facility so that articles can be retrieved at any location from a storage container in the transfer storage bay 24 and placed on any location of the half 713a of the belt conveyor 712.

In the exemplary embodiment shown, the transfer storage bay 24 is provided in the long-term storage 8 adjoining the picking facility 1. Then, the storage and retrieval machines 811 moving on the transport plane 815 place a storage container 92″′, from which articles are to be retrieved for the short-term storage of the picking facility 1, in this transfer storage bay 24.

Alternatively, the transfer storage bay 24 can also be a functional part of the crate stack storage 81, in which case the highest possible layer of a grid location of the crate stack adjoining the picking facility 1 functionally forms the transfer storage bay 24 of the transfer interface 7. The locations therebelow remain available for the long-term storage 8. However, respective individual storage locations of the transfer storage bay 24 are temporarily unavailable when the crate stack storage device 81 needs to access storage containers in the lower layers of the crate stack below the transfer bay 24.

The storage and retrieval machine 25, 253 also has a manipulator device 254 in the form of a robot gripping arm moveable transversely to the shelf and also in the longitudinal direction of the shelf. This arm can retrieve articles 91 from a second half 713b of the belt conveyor 712 of the transfer interface 7 and place them on a shelf tray 22″′ held available by the storage location transfer device 25.

When required, the belt conveyor 712 advances the conveyor belt to the right by half a conveyor length, so the articles placed in the first half 713a by the first manipulator device 711 of the transfer interface 7 reach the second half 713b, where they are accepted by the second manipulator device 254 of the storage and retrieval machine 253 and placed on the shelf tray 22″ carried with it.

When required, the storage and retrieval machine 253 places the shelf tray 22″ in an empty storage bay 22 and replaces it with a different shelf tray.

Advantageously, the belt conveyor 712 has multiple conveyor belts that are parallel and can be actuated independently from one another. This allows a more efficient operation of the transfer interface 7 as occupation and throughput of the belt conveyor 712 can be increased.

The picking facility 1 illustrated has a picking station 3 and a picking device 3a. A picking station 3 is provided for manual operation. An operator (not illustrated) can retrieve articles from a shelf tray 22′ placed on the picking location 32 through an access opening 34 and place them on a conveying device (not illustrated) provided outside of the picking facility 1 or in a collector provided for the picking order.

A picking device 3a is provided for automated operation. It comprises a belt conveyor 37 disposed on a picking location 32a. The manipulator device 254 of the storage and retrieval machine 253 can retrieve articles 91 from a shelf tray 22″ carried with it and place them on the belt conveyor 37. Thereupon, the belt conveyor 37 conveys the articles 91″ to a filling device 523 of an overhead conveying system 52, 522 as already shown and described for FIG. 12 in an analogous manner Once an article is identified by an optical detection device 511 and/or an RFID reader device 512, 513, the belt conveyor 37 advances the article to a slide chute 524, on which it reaches the transport pouch 525 of a provided overhead conveying unit.

The width of the belt conveyor 37 in the shown example of an automated picking device 3a is substantially directed by the width of the transport pouch 525. In order to allow better use of the available space in the longitudinal direction of the picking facility and reach a higher throughput capacity, multiple parallel belt conveyors can be provided, which place articles one by one in a slowly advanced transport pouch.

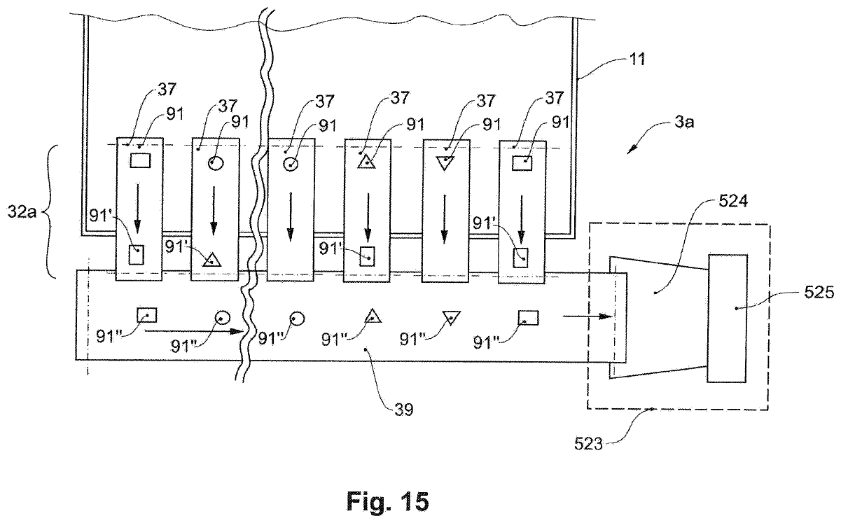

Another advantageous embodiment variant of an automated picking device 3a of a picking facility according to the invention is shown in FIG. 15.

On the picking location 32a, a high number of parallel belt conveyors 37 is disposed, on which a manipulator device of the storage and retrieval machine (not illustrated) can place articles 91, 91′, 91″. The parallel belt conveyors 37 convey the articles to a collecting conveyor 39 disposed outside of the housing 11 of the picking facility in the longitudinal direction below the level of the belt conveyors 37. The collecting conveyor 39 can also be designed as a belt conveyor, or as a tray conveyor as well.

The collecting conveyor 39 conveys the articles 91″ to the right to a slide chute 524 of a filling device 523 of an overhead conveying system, on which they reach a provided transport pouch 525 of an overhead conveying device.

Such a picking facility allows a very efficient compilation of picking orders. For example, as shown in FIG. 15, sets 91, 91′, 91″ of articles each forming a picking order together can be placed on the parallel belt conveyors 37 such that they can be placed on the collecting conveyor 39 as sets of articles at substantially the same time. In the example shown, the articles 91″ of a certain picking order were placed on the collecting conveyor 39 before and can now be put into the provided transport pouch 525 swiftly and efficiently as a set. Once this process is completed, the parallel belt conveyors 37 are activated again and place the next set of articles 91′ of the next picking order on the collecting conveyor 39, which again fills them into a different transport pouch together.

Alternatively, a tray conveyor can also be provided as the collecting conveyor 39. In such a case, the collecting conveyor can be advanced in a clocked manner, for example. The belt conveyors 37 each place articles of a certain picking order into a certain tray or a set of successive trays of the tray conveyor such that ultimately all articles of a certain picking order are placed in a tray and/or in a set of successive trays.

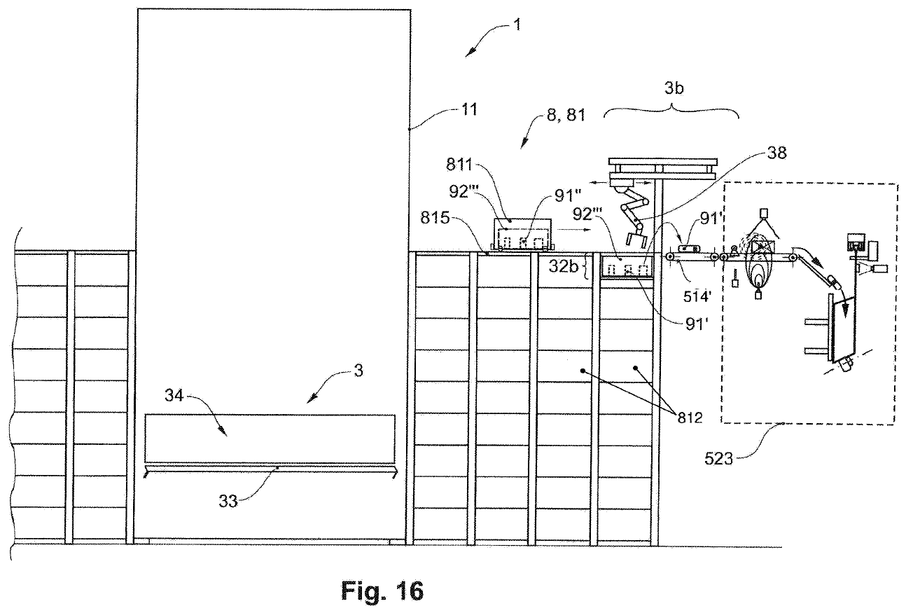

Instead of using dedicated conveying devices, an automated picking device 3b of a picking facility 1 according to the invention can also use conveying means of the upstream long-term storage 8 to transfer the articles of a picking order to a downstream conveying system 52. Such an embodiment variant is illustrated in FIG. 16.

In its interior, the picking facility 1 is designed substantially analogous to the picking facility from FIG. 8(a) or FIG. 14, having a short-term storage 2 in the form of a shelf storage 27, 27′ in which shelf trays 22 can be stored moveably in storage bays 21.

The transfer interface 7 can be designed as in FIG. 8(a), having a manipulator device 254 of the storage and retrieval machine 25, 253, which can transfer articles 91 between storage containers 92″ in the transfer storage bay 24 and a shelf tray 22″ carried with it.

Alternatively, the transfer interface 7 can be designed as in FIG. 14, having a manipulator device 254 of the storage and retrieval machine 25, 253, which can transfer articles 91 between the belt conveyor 712 and a shelf tray 22″ carried with it, and a manipulator device 711, which can transfer articles 91 between the belt conveyor 712 and storage containers 92″ in the transfer storage bay 24 outside of the housing 11 of the picking facility 1.

In such an embodiment, the transfer interface 7 is used, as before, for relocating articles from the long-term storage 8, 81 to the short-term storage 2 of the picking facility 1. In addition, however, it is also used to convey articles from a shelf tray 22″ held available by the storage and retrieval machine 253 into provided empty storage containers 92″′ in the transfer storage bay 24. In this way, the articles of a certain picking order can be collected in one or more storage containers 92″′.

When the articles required for a picking order are present in the at least one storage container in the transfer storage bay 24, these respective storage containers 92″′ can be retrieved from the transfer storage bay 24 by the storage and retrieval machines 811 of the crate stack storage device 81 and conveyed to a picking location 32b of the automated picking device 3b on the transport plane 815.

The picking location 32b comprises a storage bay, into which a storage and retrieval machine 811 can place a storage containers 92′″. In the exemplary embodiment shown, the storage bay is disposed on the highest plane of a storage slot (812) of the crate stack storage (81).

A laterally moveable manipulator device 38 in the form of a robot gripping arm allows retrieving the articles 91′ from the storage container 92″′ in the storage bay of the picking location 32b and placing them on a belt conveyor 514′. Then, the belt conveyor 514′ conveys the articles 91′ one by one to a filling device 523 for an overhead conveying system of the downstream conveying system as already discussed. The filling device 523 identifies the articles and stores them in a provided transport pouch of an overhead conveying unit.

Instead of being directly conveyed to the picking device 3b, the storage containers including the articles of a picking order can also be subject to intermediate storage in the long-term storage 8. This allows compensating capacity shortages at the transfer interface 7 and/or the picking device 3b and using the available transport capacities in an optimal way.

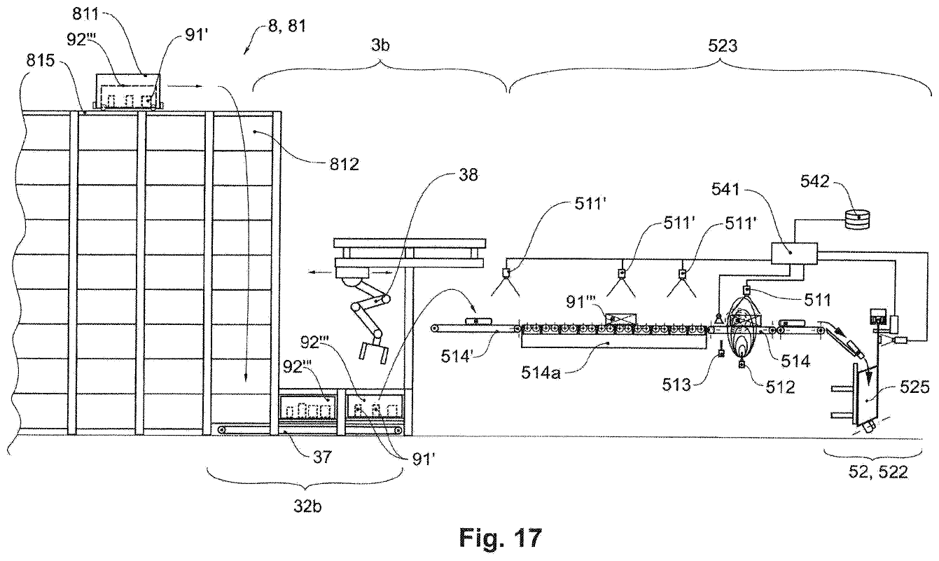

A further such variant of an automated picking device 3b is shown in FIG. 17. In an analogy to the preceding FIG. 16, the storage containers 92″′ prepared in the transfer interface of the picking facility (not visible) are retrieved from the transfer storage bay of the transfer interface by storage and retrieval machines 811 of the long-term storage 8 in the form of a crate stack storage device 81 and conveyed to the picking device 3b on the transport plane 815.

In the exemplary embodiment shown, the picking location 32b comprises a belt conveyor 37 with a first longitudinal end disposed in a storage bay at the bottom of a storage slot 812 of the crate stack storage 81. A storage and retrieval machine 811 can approach the respective storage slot 812 and place the storage container 92″′ on the belt conveyor 37.

The belt conveyor 37 conveys the storage container 92″′ further to the right, wherein the belt conveyor 37 also acts a buffer as in the example shown three storage containers can be placed on the belt conveyor. A manipulator device 38 in the form of a moveable robot gripping arm retrieves the articles 91′ from the storage container 92″′ at the second longitudinal end of the belt conveyor 37 and places them on a belt conveyor 514′ of the filling device 523. The now empty storage container is removed from the belt conveyor 37 and put aside to be used again in the long-term storage 8.

Instead of a belt conveyor, the picking location 32b of the picking device 3b can also have a carousel conveyor disposed with a loading location at the bottom of a storage slot 812 of the crate stack storage 81. A manipulator device 38 can then retrieve the articles 91′ from the storage container at a different location of the carousel conveyor. Once all required articles are retrieved, the carousel conveyor is rotationally advanced by one position. Such an embodiment has the advantage that there cannot be an overload.

The belt conveyor 514′ advances the article 91″′ to a live roller conveyor 514a on which the articles can be provided in a space-saving manner. Using a series of detection units 511′, a control unit 541 can determine the positions of the articles on the roller conveyor 514a in order to drive the individual rollers of the roller conveyor 514a accordingly.

From the roller conveyor 514a, the articles are advanced one by one to a belt conveyor 514, where the respective article is identified by an optical detection unit 511 and/or an RFID reader unit 512, 513. If the identity of the article matches the target value, it is dropped via a slide chute into a transport pouch 525 of a provided overhead conveying unit of an overhead conveying device 522, where the articles of the picking order are collected. The control unit 541 connects the data of the stored articles in a database 542 to the identity of the overhead conveying unit.

The scope of the present invention is not limited to the specific embodiments described herein. Rather, various further modifications of the present invention in addition to the examples disclosed herein, which also fall into the protective scope of the claims, will be apparent for those skilled in the art from the description and the associated figures.

Furthermore, various references are cited in the description, the disclosures of which are incorporated in the description in their entirety by reference.

1-61. (canceled)

62. A storage system, comprising:
a long-term storage in the form of a crate stack storage device for storing a plurality of storage containers, in which piece goods can be stored, wherein the crate stack storage device has at least one storage and retrieval machine capable of retrieving, moving and placing storage containers within the crate stack storage device;
a downstream conveying system;
an automated picking device, having a picking location, on which a storage and retrieval machine of the crate stack storage device can place one or more storage containers; and
a processing station that is configured to transfer piece goods supplied by the automated picking device to the downstream conveying system of the storage system; wherein the processing station is a filling device for the overhead conveying system;
wherein the automated picking device has a manipulator device or a robot arm configured to retrieve piece goods from a storage container on the picking location and directly transfer the piece goods to the processing station, or to a belt conveyor of the automated picking device that is connected to the processing station in terms of conveying.

63. The storage system according to claim 62, wherein the picking location of the automated picking device has a belt conveyor, and wherein a storage and retrieval machine of the crate stack storage device can place one or more storage containers on the belt conveyor.

64. The storage system according to claim 62, wherein the picking location of the automated picking device comprises at least one storage bay inside a storage slot of the crate stack storage device.

65. The storage system according to claim 62, wherein the manipulator device of the automated picking device is laterally moveable.

66. The storage system according to claim 63, wherein a first longitudinal end of the belt conveyor is disposed in a storage bay at the bottom of a storage slot of the crate stack storage.

67. The storage system according to claim 66, wherein the manipulator device of the automated picking device in the form of a movable robot gripping arm is configured to retrieve articles from a storage container at a second longitudinal end of the belt conveyor and to place them on a belt conveyor of the filling device.

68. The storage system according to claim 65, wherein the laterally moveable manipulator device of the automated picking device is configured to retrieve articles from a storage container in a storage bay of the picking location and to place them on a belt conveyor of the filling device.

69. The storage system according to claim 67, wherein the belt conveyor of the filling device is configured to convey the articles placed on it by the manipulator device one by one to a filling device.

70. The storage system according to claim 62, wherein the picking location of the picking device has a carousel conveyor that is disposed with a loading location at the bottom of a storage slot of the crate stack storage, and wherein the manipulator device of the automated picking device is configured to retrieve articles from a storage container at a different location of the carousel conveyor.

71. The storage system according to claim 62, comprising a picking facility for picking piece goods, which is connected to the long-term storage in terms of conveying;
wherein the picking facility comprises:
a storage device having a plurality of shelf trays on which piece goods and/or storage containers with piece goods can be placed; having a plurality of storage bays, in which the shelf trays can be placed; and having a storage location transfer device configured to transfer shelf trays from one storage bay to a different storage bay;
a picking station having at least one picking location, on which a shelf tray can be placed, wherein the at least one picking location is also a storage bay of the storage device; and
a conveying device configured to convey piece goods placed on the conveying device to a downstream processing station;
wherein the picking station and/or the picking device of the picking facility has a transfer device configured to receive piece goods and place it on the at least one conveying device.

72. The storage system according to claim 71, wherein the storage device of the picking facility is implemented as a vertically circumferential paternoster shelf storage, having a storage location transfer device designed as a paternoster conveyor with a plurality of shelf trays, on which piece goods and/or storage containers with piece goods can be placed, so that the storage location transfer device can convey the shelf trays along the various storage bays of the storage device.

73. The storage system according to claim 71, wherein the storage device of the picking facility is implemented as a shelf storage, having one or two shelf units, each including a plurality of storage bays disposed above one another; and wherein the storage location transfer device has a storage and retrieval machine configured to transfer a shelf tray from one storage bay to a different storage bay.

74. The storage system according to claim 71, wherein the picking facility has a picking device with a picking location, and wherein the picking device comprises a horizontal conveying device that is arranged on the picking location, and onto which piece goods can be placed by a storage and retrieval machine of the picking facility; wherein the horizontal conveying device is configured to convey piece goods placed on the horizontal conveying device to a downstream processing station.

75. The storage system according to claim 74, wherein the storage and retrieval machine of the picking facility has a manipulator device capable of placing piece goods on the horizontal conveying device of the picking device.

76. The storage system according to claim 74, having a processing station configured to transfer piece goods supplied by a conveying device of the picking facility to a downstream conveying system of the storage system, wherein the downstream conveying system of the storage system is an overhead conveying system or an overhead pouch conveying system.

77. The storage system according to claim 71, having a transfer interface configured to place storage containers from an upstream storage device on a shelf tray that is disposed in a storage bay of the storage device of the picking facility provided for this transfer.

78. The storage system according to claim 77, wherein the at least one storage and retrieval machine is configured to accept storage containers from the transfer interface and convey them within the long-term storage to the processing station and/or to the picking device, and/or to transfer storage containers from the long-term storage to the transfer interface.
